(19) United States
(12) Patent Application Publication
(10) Pub. No.: US 2026/0087075 A1
(43) Pub. Date: Mar. 26, 2026

(54) NETWORK INTERFACES AND MESSAGING SCHEMES FOR AUTOMATING SEQUENTIAL AUTHORIZATION PROCESSES

(71) Applicant: Optum, Inc., Minnetonka, MN (US)

(72) Inventors: Lauren A. HACKENBERG, Wexford, PA (US); Janel L. SCOTT, Hudson, WI (US); Peter CHAU, Missouri City, TX (US); Ravi K. KUKKAPALLI, Collierville, TN (US)

(21) Appl. No.: 18/887,561

(22) Filed: Sep. 17, 2024

Related U.S. Application Data
(60) Provisional application No. 63/551,769, filed on Feb. 9, 2024.

(51) Int. Cl. G06F 16/9038; G06F 16/901

(52) U.S. Cl. CPC G06F 16/9038; G06F 16/9027

(57) ABSTRACT

Various embodiments of the present disclosure provide network interfaces and messaging schemes for enabling cross-entity collaboration through a sequential, multi-party authorization process. The multi-party authorization process may include receiving a request with an automation indicator and, in response to the automation indicator, identifying an automated decision tree for an automated query message request. The automated query message request may be provided to a querying entity that may execute the automated decision tree and respond with an automated query message response with a sequence of query responses. The multi-party authorization process may include determining a query completion status of the automated query message response based on the sequence of query responses and, in response to the query completion status identifying a complete query response, providing an authorization message response with a predictive response derived from the sequence of query responses.

### RELATED APPLICATIONS

This application claims the benefit of U.S. Provisional Application No. 63/551,769, entitled “AUTOMATED PRIOR AUTHORIZATION WORKFLOW,” and filed Feb. 9, 2024, the entire contents of which are herein incorporated by reference.

### BACKGROUND

Various embodiments of the present disclosure address technical challenges related to network-based authorization processes, such as those that leverage information from multiple, secure, and disparate data sources. Traditional authorization processes may leverage decision logic defined by a first computing entity to enforce authorization decisions for one or more second computing entities. In such a case, the decision logic is defined by an entity that does not have access to the information necessary to enforce the decision logic. The isolation of various entities involved in the authorization process leads to several technical disadvantages, including inefficient use of computing resources due to redundant operations, increased time constraints for performing an authorization process, an inability to automate the authorization process, among other disadvantages discussed herein.

As one practical example of these technical challenges, in a prior authorization process, clinical guidelines for authorizing a medical prescription may be defined by a prescriber of the medication. The clinical guidelines may be enforced by a medical insurer each time a new prescription is ordered by a healthcare provider. However, the information necessary to enforce the clinical guideline is only accessible to the health care provider due to privacy constraints, which results in a number of redundant communications between the healthcare provider (and/or an intermediary entity) and the medical insurer. A lack of communication interfaces between the medication prescriber, the medical insurer, and the healthcare provider prevents the automation of the prior authorization process, while increasing time delays and processing resource expenditure due to redundant and excessive network communications.

Various embodiments of the present disclosure make important contributions to traditional network-based authorization techniques to address these technical challenges, among others.

### BRIEF SUMMARY

Various embodiments of the present disclosure address the above-described technical challenges by providing network interfaces and messaging schemes to implement a sequential authorization process through entity-to-entity collaboration that is traditionally prevented due, in part, to security constraints restricting communications between various computing entities within an ecosystem. Some techniques of the present disclosure provide messaging schemes that leverage communication interfaces between various computing entities within an ecosystem. The communication interfaces define a plurality of message requests, responses, and updates that enable a central computing entity to leverage the security infrastructure of other entities within the ecosystem. By doing so, a central computing entity, such as an authorization system of the present disclosure, may implement a sequential authorization process in which the authorization of a request is automated and exceptions to the automated authorization process are efficiently handled. For example, an authorization system may generate automated decision trees that define query logic tailored to a specific query system with access to a system-specific data source. In response to a request from the specific query system, the authorization system may provide the automated decision trees for execution by the specific query system. Query responses received through the execution of the automated decision tree may be processed by the authorization system to automatically detect and handle exceptions to the automated query process. In response to an exception, the authorization system may respond with a natural language decision logic to continue the authorization process based on user input. In this manner, the network interfaces and messaging schemes of the present disclosure may enable the collaboration between a plurality of computing entities within an ecosystem to improve the automation of a traditionally manual authorization process, while complying with data security measures enforced within an information domain.

In some embodiments, a computer-implemented method includes receiving, by one or more processors, an authorization message request comprising an automation indicator; identifying, by the one or more processors, the automation indicator from the authorization message request; in response to identifying the automation indicator, (i) identifying, by the one or more processors, an automated decision tree associated with the automation indicator, and (ii) providing, by the one or more processors, an automated query message request comprising the automated decision tree; receiving, by the one or more processors, an automated query message response comprising a sequence of query responses corresponding to one or more query branches of the automated decision tree; determining, by the one or more processors, a query completion status of the automated query message response based on the sequence of query responses; and in response to the query completion status identifying a complete query response, providing, by the one or more processors, an authorization message response comprising a predictive response based on the sequence of query responses.

In some embodiments, a computing system includes memory and one or more processors communicatively coupled to the memory, the one or more processors are configured to receive an authorization message request comprising an automation indicator; identify, the automation indicator from the authorization message request; in response to identifying the automation indicator, (i) identify an automated decision tree associated with the automation indicator, and (ii) provide an automated query message request comprising the automated decision tree; receive an automated query message response comprising a sequence of query responses corresponding to one or more query branches of the automated decision tree; determine a query completion status of the automated query message response based on the sequence of query responses; and in response to the query completion status identifying a complete query response, provide an authorization message response comprising a predictive response based on the sequence of query responses.

In some embodiments, one or more non-transitory computer-readable storage media include instructions that, when executed by one or more processors, cause the one or more processors to receive an authorization message request comprising an automation indicator; identify, the automation indicator from the authorization message request; in response to identifying the automation indicator, (i) identify an automated decision tree associated with the automation indicator, and (ii) provide an automated query message request comprising the automated decision tree; receive an automated query message response comprising a sequence of query responses corresponding to one or more query branches of the automated decision tree; determine a query completion status of the automated query message response based on the sequence of query responses; and in response to the query completion status identifying a complete query response, provide an authorization message response comprising a predictive response based on the sequence of query responses.

### BRIEF DESCRIPTION OF THE DRAWINGS

FIG. 1 provides an example overview of an architecture in accordance with some embodiments of the present disclosure.

FIG. 2 provides an example computing entity in accordance with some embodiments of the present disclosure.

FIG. 3 provides an example client computing entity in accordance with some embodiments of the present disclosure.

FIG. 4 is an interaction diagram showing example computing entities and messaging schemes for implementing a sequential authorization process in accordance with some embodiments discussed herein.

FIGS. 5A-C are dataflow diagrams showing example data structures and modules for implementing a sequential authorization process in accordance with some embodiments discussed herein.

FIGS. 6A-B are operational examples of decision logics in accordance with some embodiments discussed herein.

FIG. 7 is a flowchart diagram of an example sequential authorization process in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

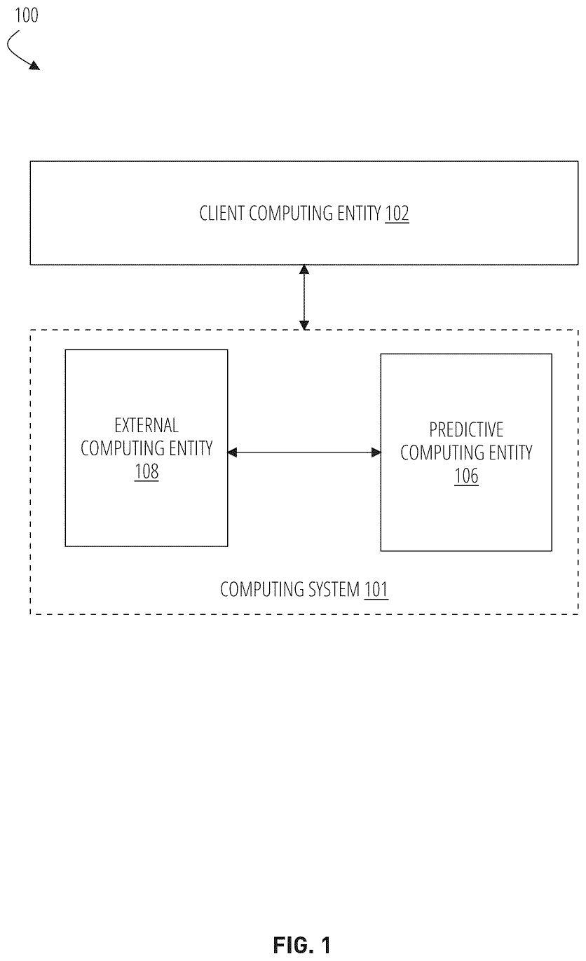

FIG. 1 provides an example overview of an architecture 100 in accordance with some embodiments of the present disclosure. The architecture 100 includes a computing system 101 configured to receive requests, such as generative text requests, from client computing entities 102, process the requests to generate generative text outputs, and provide the generated text outputs to the client computing entities 102. The example architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, one or more machine learning models may be trained to generate predictive insights in various forms, such as textual response explanations, and/or the like. The models may form at least a portion of a sequential authorization process that may be configured to generate predictive responses for an authorization process. This technique will improve the performance of authorization processes through sequential authorization operations, while reducing processing and memory resource demands of remote authorization.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive messages, and/or the like, from client computing entities 102, process the messages to generate outputs, and provide the generated outputs to the client computing entities 102. The generated outputs, for example, may include prompts, authorization responses, and/or the like.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., authorization techniques, communication techniques, and/or the like) described herein. The external computing entities 108, for example, may include and/or be associated with one or more entities that may be configured to receive, transmit, store, manage, and/or facilitate datasets, such as the system-specific data source, historical message data store, authorization data store, and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data, etc.) from the use of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

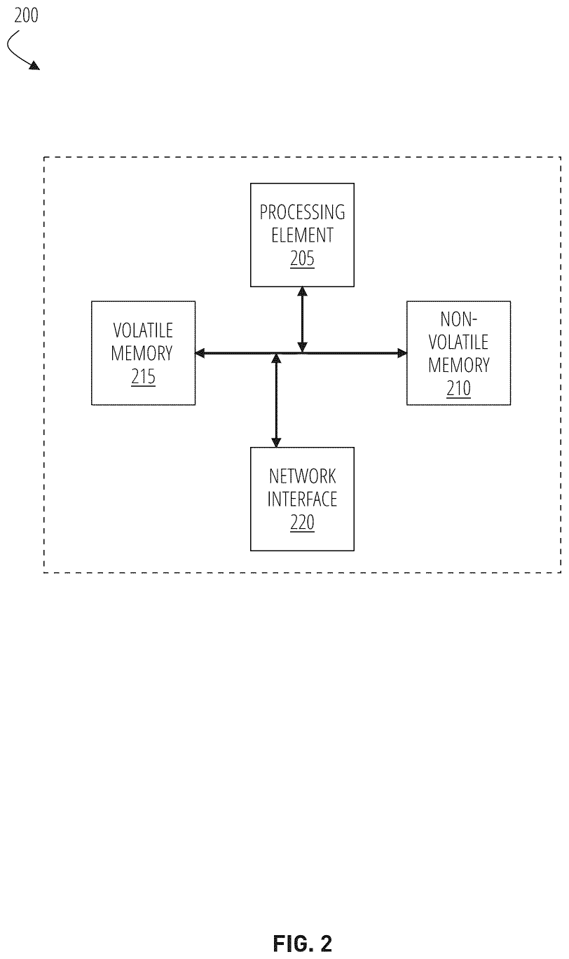

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

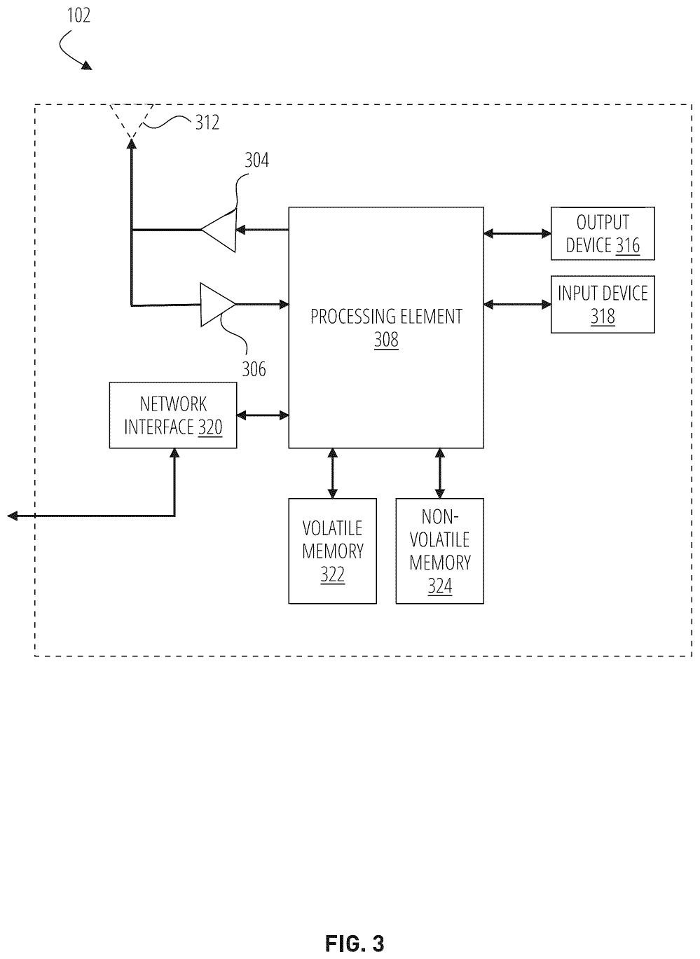

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. Examples of Certain Terms

In some embodiments, the term “authorization computing ecosystem” refers to an ecosystem of computing entities that are collectively configured to perform an authorization process. An authorization computing ecosystem, for example, may include a plurality of computing entities that are communicatively connected through one or more communication interfaces. The communication interfaces, for example, may include application programming interfaces (APIs), file based interfaces, message queue based interfaces, and/or the like. For instance, a communication interface may include an authorization API including, as examples, one or more simple object access protocol (SOAP) APIs, one or more remote procedure call (RPC) APIs, one or more WebSocket APIs, one or more Representational State Transfer (REST) APIs, and/or the like. In some embodiments, an authorization interface may include one or more RPC APIs, such as one or more gRPC APIs.

The computing entities of the authorization computing ecosystem may communicate, via the communication interfaces, to perform a multi-party authorization workflow. The multi-party authorization workflow, for example, may authorize or deny a request from an originating computing entity, such as a provider system. The request may be authorized or denied through interactions between one or more intermediary computing entities. For example, a first intermediary computing entity, such as a query system, may receive and forward a request to a second intermediary computing entity, such as an authorization system. The authorization system may interact with the query system to retrieve authorization information from a user and/or one or more system-specific data sources and then provide an authorization response, directly or indirectly through the query system, to the origination computing entity. In this manner, an authorization computing ecosystem may facilitate an authorization process through a plurality of entity-to-entity interactions between a plurality of computing entities.

In some embodiments, the communication interfaces include an authorization API that defines a plurality of entity-to-entity messages for facilitating an authorization process. The authorization API, for example, may define a plurality of request, response, and/or update messages that enable each of the computing entities within the authorization computing ecosystem to interact with each other to perform one or more authorization operations. The authorization API may provide flexibility to an authorization system that allows the authorization system to interact with a plurality of query systems respectively connected with a plurality of disparate, system-specific data sources. By doing so, a central authorization system of an authorization computing ecosystem may enforce, facilitate, and, in some cases, automate authorization decisions for a plurality of provider and query systems.

In some embodiments, the term “query system” refers to a computing entity of an authorization computing ecosystem. A query system, for example, may include a computing system, platform, and/or device that is configured to perform one or more operations of the present disclosure to initiate a query to one or more system-specific data sources. In some examples, a query system may include an intermediary system between a provider system and an authorization system. The query system, for example, may forward and return messages between a provider system and an authorization system to facilitate an authorization of a message for a provider system in accordance with one or more authorization criteria enforced by the authorization system.

In some embodiments, a query system is integrated, through one or more query APIs, with one or more system-specific data sources. For example, a query system may have access to query APIs with a system-specific data source that enables retrieval of information from the system-specific data source. In some examples, a query system may leverage the one or more query APIs, and/or one or more other pre-established connections, to perform a query on behalf of an authorization system. For example, the query system may receive query logic from an authorization system and execute the query logic to perform a query to a system-specific data source.

In some embodiments, the term “system-specific data source” refers to a data storage entity configured to store, maintain, and/or monitor a data catalog. For example, a system-specific data source may include a heterogenous data store that is configured to store a data catalog using specific database technologies, such as Netezza, Teradata, and/or the like. A system-specific data source, for example, may include a data repository, such a database, and/or the like, for persistently storing and managing collections of structured and/or unstructured data (e.g., catalogs, etc.). In some examples, a system-specific data source, and/or a data catalog thereof, may include sensitive information that is stored in compliance with one or more security measures. By way of example, in a clinical domain, a system-specific data source may include a plurality of electronic health records (EHRs) for subscribing patients of a particular health institution. In such a case, the system-specific data source may include robust data governance protocols for accessing, retrieving, and/or initiating queries to a data catalog. In some examples, the data governance protocols may establish one or more approved querying entities, which may include a query system.

In some embodiments, the term “provider system” refers to a computing entity of an authorization computing ecosystem. A provider system, for example, may include a computing system, platform, and/or device that is configured to perform one or more operations of the present disclosure to initiate an authorization message request that may require an authorization process. In this regard, a provider system may include any system that provides a provider request to initiate an authorization message request between a query system and an authorization system. A provider system may be different depending on the information domain. As one example, in a clinical information domain, a provider system may include a clinical system owned, operated, and/or the like by a clinical provider. For instance, a provider system may be interacted with by a clinical provider to provide a prior authorization request to an authorization system.

In some examples, a provider system may facilitate one or more user interactions to perform one or more portions of an authorization process. For example, a provider system may include one or more client devices, with one or more input/output elements, configured to receive user input (e.g., via one or more keyboards, touchpads, etc.) and provide user interpretable information (e.g., via a display, speaker, etc.) to a user. The user input, for example, may be received by the provider system and used to initiate an authorization message request and/or interact with a natural language decision logic to facilitate an authorization message response.

In some embodiments, the term “authorization system” refers to a computing entity of an authorization computing ecosystem. An authorization system, for example, may include a computing system, platform, and/or device that is configured to perform one or more operations of the present disclosure to enforce, facilitate, and/or otherwise engage in an authorization process. For instance, an authorization system may be configured to generate, store, and/or communicate one or more decision logics that are tailored to a particular predictive response. The decision logic, for example, may include an automated decision tree and/or natural language decision logics for a particular predictive response. The decision logic may depend on an information domain. As one example, continuing the clinical domain example herein, the decision logic may correspond to criteria for a prior authorization decision with respect to a particular clinical service, such as a medication prescription, and/or the like.

In some embodiments, an authorization system generates one or more decision logics from platform criteria that define restrictions to a predictive response. In a clinical domain, the platform criteria, for example, may include clinical guidelines established by a medication prescriber. An authorization system may enforce, facilitate, and/or otherwise engage in an authorization process by initiating queries to one or more query systems in accordance with the one or more decision logics and, in response to query responses for the initiated queries, determine and provide an authorization response to a provider system.

In some embodiments, the term “authorization data store” refers to a data structure that describes a plurality of authorization data objects respectively corresponding to a plurality of secured identifiers of an information domain. An example authorization data store may include any type (and any number) of data storage structures including, as examples, one or more linked lists, databases (e.g., relational databases, graph database, etc.), and/or the like. In some embodiments, an authorization data store may include a plurality of authorization data objects, each reflective of a secured identifier and one or more decision logics corresponding to the secured identifier. In addition, or alternatively, an authorization data object may include a source document and/or a reference (e.g., a source identifier) to a source document.

In some examples, a source document includes structured and/or natural language text that describes criteria for authorizing an action with respect to a particular secured identifier. A secured identifier, for example, may correspond to a service, product, data, and/or any other tangible or intangible item that may be subject to one or more authorization criteria. By way of example, in a clinical prior authorization process, a secured identifier may correspond to a clinical service, prescription, and/or the like that is subject to one or more regulatory and/or insurance restrictions. In any information domain, one or more restrictions, or “authorization criteria,” may be established for a secured identifier through one or more source documents.

In some examples, a source document may include natural language text that is uninterpretable to a computer and potentially misleading during manual review. To improve the efficiency of an authorization process, one or more decision logics may be generated from a source document. The one or more decision logics may include one or more decision trees, and/or any other data structure, that separates criteria from a source document into a plurality of single question-answer units. For example, the one or more decision logics may include a natural language decision logic and/or an automated decision tree. In some examples, each of the authorization data objects may include a natural language decision logic. In addition, or alternatively, one or more of the authorization data objects may be augmented with an automated decision tree. In some examples, the natural language decision logic and/or the automated decision tree may be automatically and individually generated, using one or more natural language processing (NLP) techniques from a source document (e.g., natural language clinical guidelines in a clinical domain, etc.).

In some examples, the generation of an automated decision tree may leverage additional upfront processing resources compared to natural language decision logic to conserve processing resources during the execution of downstream authorization processes. To optimize computing resource usage, an automated decision tree may be generated for a set of automated identifiers filtered from a plurality of secured identifiers of the information domain. In some examples, the set of automated identifiers may be filtered based on a frequency of use. For example, the set of automated identifiers may be identified based on a frequency of use across a plurality of historical data objects for the information domain. The historical data objects, for example, may include a plurality of historical authorization message requests, a plurality of historical user interactions, and/or the like. By way of example, in a clinical information domain, the set of automated identifiers may be identified based on historical drug prescription frequencies for a particular provider and/or a cohort of providers.

In some examples, an authorization data object that includes an automated decision tree may be flagged with an automation indicator. For instance, an automation indicator may be stored in the authorization data object. In addition, or alternatively, a secured identifier of the authorization data object may be stored with an automation indicator. In some examples, a plurality of automation indicators, respectively corresponding to a plurality of secured identifiers, may be provided to one or more computing entities, such as a query system, of an authorization computing ecosystem. In some examples, the query system may store the secured identifiers and corresponding automation indicators for use in providing an authorization message request to the authorization system of the authorization computing ecosystem.

Each of the elements of an authorization data object may depend on an information domain and may apply to any information domain in which access to a service, product, and/or the like is restricted in accordance with one or more criteria. By way of example, using a clinical information domain as an example, a secured identifier may correspond to a drug prescription, a source document may correspond to clinical guideline documentation for the drug prescription, and the decision logics may correspond to structured rules extracted from the clinical guideline documentation for authorizing the drug prescription. The structured rules, for example, may be extracted as a natural language decision logic that may be resolved by a clinical professional or an automated decision tree that may be resolved through queries to an EHR system accessible to a query system. As described herein, the decision logics may be intelligently surfaced to a query system during the automated prior authorization workflow to conserve computing resources while completing a prior authorization request.

In some embodiments, the term “natural language decision logic” refers to a data structure that includes one or more logic statements, each describing a natural language question for a secured identifier. In some examples, a natural language decision logic may include a plurality of conditional statements. Each conditional statement may include a prompt and a conditional logic for moving to a subsequent conditional statement of the natural language decision logic. In some examples, a prompt of a conditional statement may include natural language text that may be provided to a user to prompt user input in response to the conditional statement. A conditional logic of the conditional statement may define an action in response to the user input. The action, for example, may define a subsequent conditional statement of the natural language decision logic. The natural language decision logic may terminate with a predictive response for a secured identifier.

In some embodiments, a natural language decision logic is derived from a source document that defines criteria for a response with respect to a secured identifier. For example, the criteria may include one or more conditions for authorizing a secured identifier. In some examples, a natural language decision logic may include one or more conditional statements for each of the one or more conditions defined by the source document. In this manner, a natural language decision logic may define a sequence of interactive natural language prompts to sequentially collect information for determining a response for a secured identifier in accordance with criteria defined for the secured identifier. In this way, a natural language decision logic may break down a source document into a series of easily consumable questions that may be efficiently surfaced to a user. However, the questions are specific to users and are uninterpretable to a query system making natural language decision logic unable to support automated queries to data sources, other than users, that may be capable of answering a question without user input.

In some embodiments, the term “automated decision tree” refers to a data structure that includes one or more logic statements, each describing a computer-interpretable query for a secured identifier. In some examples, an automated decision tree may include a plurality of conditional queries. Each conditional query may include a query and a conditional logic for moving to a subsequent conditional query of the automated decision tree. In some examples, a query of a conditional query may include query logic for initiating a query to a system-specific data source. The query logic, for example, may be executable by a query system to initiate a query to a system-specific data source and, in response to the query, receive a query response from the system-specific data source. The query logic, for example, may include an executable instruction for retrieving a particular data value type from a record accessible to a query system. A conditional logic of the conditional query may define an action in response to the query response. The action, for example, may define a subsequent conditional query of the automated decision tree. The automated decision tree may terminate with a predictive response for a secured identifier.

In some embodiments, an automated decision tree includes a decision tree structure with a plurality of linked nodes. For example, an automated decision tree may include a plurality of query branches. Each query branch may include one or more connected nodes that begin at start node and end at a terminating node. Each of the query branches may terminate at a terminal node that reflects a particular predictive response for a secured identifier. For example, for a binary authorization response, each of the query branches may terminate at an authorized node or an unauthorized node.

In some examples, each node of the automated decision tree may correspond to a conditional query. For instance, each node may include a query logic for executing a query of a conditional query and routing logic for executing a conditional logic of the conditional query. The routing logic, for example, may include an executable instruction for routing from a current node to a subsequent node in the automated decision tree based on a query response to the query logic. In some examples, the routing logic for each node may require a query response to traverse from the node to a subsequent node. In this manner, each branch of an automated decision tree may define a plurality of queries that require answers to reach a predictive response.

In some examples, an automated decision tree may correspond to an automation indicator and/or a secured identifier associated with an automation indicator. For example, an automated decision tree may be stored in association with an automation indicator and/or secured identifier (e.g., in an authorization data object, etc.). In this manner, an automated decision tree may be identified in response to an automation indicator and/or a secured identifier of an authorization message request. In some examples, an automated decision tree may be identified and provided in response to an automation indicator of an authorization message request.

In some embodiments, the term “automation indicator” refers to a data parameter that describes an automated capability of an authorization process with respect to a secured identifier. For example, an automation indicator may include a request field, such as a request flag, and/or the like, of a request message, such as an authorization message request. In some examples, an automation indicator may include a binary value that indicates whether a secured identifier of an authorization message request corresponds to an automated decision tree (e.g., as indicated by a lookup table, etc. periodically updated via communication with an authorization system). In addition, or alternatively, an automation indicator may include a lookup key, and/or another numeric, alpha-numeric, and/or like value that may correspond (e.g., match, etc.) a unique identifier of an automated decision tree. By way of example, an automation indicator, and/or other data indicative of an automated decision tree for a secured identifier, may be provided to a requesting system, such as a query and/or provider system, via one or more periodic update messages from an authorization system. The automation indicator, and/or other data indicative of an automated decision tree for a secured identifier, may be stored in a lookup table and/or any other accessible data structure for generating an authorization message request for a secured identifier.

In some embodiments, the term “authorization message request” refers to a data entity that defines a request to perform an authorization for a secured identifier. An authorization message request may be provided to an authorization system from a requesting system, such as a provider system, query system, and/or the like of an authorization computing ecosystem. An authorization message request may include one or more authorization parameters. The one or more authorization parameters may include a secured identifier, an authorization indicator, an entity identifier, a requesting system identifier, and/or the like. An entity identifier, for example, may include a numeric, alpha-numeric, and/or any other value that identifies a particular entity within an information domain. By way of example, in a clinical information domain, an entity may be a member for which a clinical service, prescription, and/or the like is requested.

In some examples, a message format of an authorization message request may be defined by an authorization API. For example, an authorization message request may include a predefined call between a query system and an authorization system. In this way, an authorization system may receive, from a query system, an authorization message request including one or more authorization parameters, such as a secured identifier, an authorization indicator, and/or any other parameter defined by a message format of an authorization message request. An authorization system may receive the authorization message request and respond with an authorization message response for a secured identifier of the authorization message request. In some examples, an authorization message response may be based on one or more intermediate communications between the entities of the authorization computing ecosystem.

In some embodiments, the term “automated query message request” refers to a data entity that defines an intermediate request to perform an automated query operation for an authorization process. An automated query message request may be provided to a query system from an authorization system in response to an authorization message request. An automated query message request may include one or more query parameters. The one or more query parameters may reflect an automated decision tree and/or one or more portions thereof. In some examples, the one or more query parameters may identify an automated decision tree that defines one or more query operations on behalf of an entity and a secured identifier of an authorization message request. By way of example, an automated query message request may include a plurality of conditional queries and an entity identifier on which to perform one or more queries in accordance with the conditional queries. The query, for example, may be performed on one or more entity data objects within a system-specific data source (e.g., EHRs for a patient in a clinical information domain, etc.).

In some examples, a message format of an automated query message request may be defined by an authorization API. For example, an automated query message request may include a predefined call between a query system and an authorization system. In this way, an authorization system may provide, to a query system, an automated query message request including one or more instructions to perform queries to a system-specific data source to facilitate an authorization process. A query system may receive an automated query message request, perform one or more queries in accordance with the automated query message request (e.g., an automated decision tree thereof, etc.), and respond with an automated query message response for a secured identifier and entity of the automated query message request.

In some embodiments, the term “automated query message response” refers to a data entity that defines an intermediate response reflective of a performance of one or more query operations for an authorization process. An automated query message response may be provided to an authorization system from a query system in response to an automated query message request. An automated query message response may include one or more query response parameters. The one or more query response parameters may reflect one or more query responses to one or more conditional queries of the automated query message request. In some examples, the one or more query response parameters may identify a sequence of query responses corresponding to one or more branches of an automated decision tree. For example, an authorization system may receive, from the query system, an automated query message response including a sequence of query responses that at least partially complete at least one branch of an automated decision tree. In some examples, each query response may include a data element, data value, data source, and/or any other metadata associated with a query to a system-specific data source that is performed by executing query logic of a conditional query.

In some examples, a message format of an automated query message response may be defined by an authorization API. For example, an automated query message response may include a predefined call between a query system and an authorization system. In this way, a query system may provide, to an authorization system, an automated query message response including one or more query responses retrieved responsive to an automated query message request. An authorization system may receive the automated query message response, perform an authorization process based on the one or more query responses, and respond with an authorization message request and/or another intermediate communication in accordance with the authorization process.

In some embodiments, the term “query completion status” refers to a data element that describes a state of an authorization process responsive to an automated query message response. A query completion status, for example, may reflect a proportion of a plurality of conditional queries that are executed in response to an automated query message request. For instance, a query completion status may reflect a complete and/or incomplete query response to at least a portion the plurality of conditional queries. A complete query response may reflect that a sequence of query responses from an automated query message response complete a branch of an automated decision tree. An incomplete query response may reflect that a sequence of query responses from an automated query message response do not complete a branch of an automated decision tree. By way of example, a complete query response may reflect that a sequence of query responses reaches a terminal node of an automated decision tree, whereas an incomplete query response may reflect that a sequence of query responses terminates at one or more intermediate nodes preceding a terminal node of an automated decision tree.

In some examples, an authorization system may assign a query completion status based on a comparison between one or more query responses of an automated query message response and an automated decision tree corresponding to a secured identifier. For example, a query completion status may be determined based on a determination of whether an automated query message response includes one or more query responses that reach a terminal node of an automated decision tree. In some examples, an authorization system may respond to an automated query message response with a different message based on a query completion status. For example, an authorization system may respond with an authorization message response in response to a complete query response. In addition, or alternatively, an authorization system may respond with a user query message request in response to an incomplete query response.

In some embodiments, the term “user query message request” refers to a data entity that defines an intermediate request to perform a user query operation for an authorization process. A user query message request may be provided to a query system (and/or another requesting system, such as a provider system) from an authorization system in response to an incomplete query response (or an absence of an automation indicator). A user query message request may include one or more user query parameters. The one or more user query parameters may reflect a natural language decision logic and/or one or more portions thereof for a secured identifier. In some examples, the one or more user query parameters may identify a natural language decision logic that defines one or more conditional statements on behalf of an entity and a secured identifier of an authorization message request. By way of example, a user query message request may include a plurality of conditional statements and an entity identifier for which to provide one or more prompts in accordance with the conditional statements. The prompt, for example, may be provided, via a query system and/or provider system, to a user to request user input. The user input may include a user response to a conditional statement that may be used, with the natural language decision logic, to generate a subsequent prompt for a user until the natural language decision logic terminates with a predictive response for a secured identifier.

In some examples, a message format of a user query message request may be defined by an authorization API. For example, a user query message request may include a predefined call between an authorization system and a requesting system (e.g., a query and/or provider system). In this way, an authorization system may provide, to a requesting system, a user query message request including one or more instructions to provide a sequence of user prompts to facilitate an authorization process. In some examples, a user query message request may be provided as a secondary, less efficient, authorization process in the event that an automated decision tree is not defined for a secured identifier and/or a query completion status reflects an incomplete query response for an automated decision tree of a secured identifier. In some examples, in response to an incomplete query response (or absence of an automated decision tree), an authorization system may identify a natural language decision logic for a secured identifier, generate a user query message request with the natural language decision logic, and provide the user query message request to a requesting system. A requesting system may receive a user query message request, provide one or more user prompts in accordance with the user query message request (e.g., a natural language decision logic thereof, etc.), and respond with a user query message response for a secured identifier and entity of the user query message request.

In some embodiments, the term “user query message response” refers to a data entity that defines an intermediate response reflective of a performance of one or more prompt operations for an authorization process. A user query message response may be provided to an authorization system from a requesting system in response to a user query message request. A user query message response may include one or more prompt response parameters. The one or more prompt response parameters may reflect one or more user responses to one or more conditional statements of the user query message request. In some examples, the one or more user response parameters may identify a sequence of user responses corresponding to one or more branches of a natural language decision logic. For example, an authorization system may receive, from the requesting system, a user query message response including a sequence of user responses that at least a partially complete at least one sequence of conditional statements from a natural language decision logic. In some examples, each user response may include a data element, data value, and/or any other metadata associated with user input from a user provided in response to a prompt defined by a conditional statement.

In some examples, a message format of a user query message response may be defined by an authorization API. For example, a user query message response may include a predefined call between a requesting system and an authorization system. In this way, a requesting system may provide, to an authorization system, a user query message response including one or more user responses retrieved responsive to a user query message request. An authorization system may receive the user query message response, perform an authorization process based on the one or more user responses, and respond with an authorization message request in accordance with the authorization process.

In some embodiments, the term “authorization message response” refers to a data entity that defines a response reflective of an authorization for a secured identifier. An authorization message response may be provided to a requesting system from an authorization system in response to an authorization message request. An authorization message response may include one or more authorization response parameters. The one or more authorization response parameters may include a secured identifier, an entity identifier, a predictive response, textual response explanation, and/or the like.

In some examples, a message format of an authorization message response may be defined by an authorization API. For example, an authorization message response may include a predefined call between a query system and an authorization system. In this way, an authorization system may provide, to a query system, an authorization message response including one or more authorization response parameters, such as a predictive response and/or a textual response explanation for a secured identifier of an authorization message request. An authorization system may provide the authorization message response based on an authorization process performed in response to an authorization message request.

In some examples, the authorization message response may include a predictive response that describes an authorization resolution for a secured identifier with respect to an entity. In addition, the authorization message response may include a textual response explanation that reflects a short reasoning statement for the authorization resolution. In some examples, the predictive response may be determined, by the authorization system, based on a completed branch of a decision logic, such as a query branch of an automated decision tree and/or the like.

In some examples, a predictive response and/or a textual response explanation may be determined based on one or more responses to a sequence of conditional statements (e.g., from a natural language decision logic, etc.) and/or to a sequence of conditional queries (e.g., from an automated decision tree, etc.). In some examples, an authorization message response may include a response message identifier. The response message identifier, for example, may include a numeric, alpha-numeric, and/or like value that identifies the authorization message response. In some examples, a response message identifier may be stored with a predictive response, a textual response explanation, and/or one or more responses (e.g., user responses, query responses, etc.) to a sequence of conditional statements and/or queries. For example, the response message identifier and corresponding data may be stored as a historical message data object of a historical message data store.

In some embodiments, the term “predictive response” refers to a data entity that describes an authorization resolution for a secured identifier with respect to an entity. A predictive response, for example, may include a multi-class response that is one of a plurality of categories of authorization. Each authorization category, for example, may define one or more conditions of an authorization for a secured identifier. In addition, or alternatively, a predictive response may include a binary response that is either an authorized response indicating that a secured identifier is authorized for an entity or an unauthorized response indicating that a secured identifier is not authorized for an entity. In some examples, a predictive response may be identified from a terminal node or terminal statement of a decision logic.

In some embodiments, the term “textual response explanation” refers to a data entity that describes a reasoning for an authorization resolution. A textual response explanation, for example, may include a sequence of text that describes one or more responses that contributed to a predictive response. By way of example, a textual response explanation may include a text summary of one or more query responses and/or user responses that resulted in a predictive response.

In some examples, a textual response explanation may include an extractive or abstractive summary of the one or more query responses and/or user responses. For example, a textual response explanation may be generated, using one or more NLP summarization techniques, based on the one or more query responses and/or user responses. In addition, or alternatively, a textual response explanation may include a generative text summary of the one or more query responses and/or user responses. For example, a textual response explanation may by generated, using a generative model, such as large language model (LLM), and/or the like. The LLM, for example, may include a generative pre-trained transformer (GPT) model and/or any other machine learning model with generative capabilities. In some examples, a textual response explanation may be generated by inputting a generative prompt (e.g., a no shot prompt, few shot prompt, etc.) that includes the one or more query responses and/or user responses to the generative model.

In some embodiments, the term “historical message data store” refers to a data structure that describes a plurality of historical message data objects for an information domain. An example historical message data store may include any type (and any number) of data storage structures including, as examples, one or more linked lists, databases (e.g., relational databases, graph database, etc.), and/or the like. In some embodiments, a historical message data store may include a plurality of historical message data objects, each reflective of a response message identifier, a predictive response, a textual response explanation, and/or one or more responses (e.g., user responses, query responses, etc.) to a sequence of conditional statements and/or queries.

### IV. Overview

Various embodiments of the present disclosure provide network interfaces and messaging schemes to implement a sequential authorization process through entity-to-entity collaboration. Traditionally, data security and network infrastructure constraints restrict communications between various computing entities within an authorization computing ecosystem. This results in isolated computing entities that are prevented from collaboratively and efficiently automating a multi-party authorization process. To address these deficiencies, the present disclosure provides communication interfaces that define a messaging scheme for implementing a sequential authorization process. The messaging scheme may leverage different sets of decision logic to attempt an automated authorization process and handle exceptions to the automated authorization process. For example, using the communication interfaces of the present disclosure, an authorization system may provide a first decision logic, an automated decision tree, to a query system, which may execute the automated decision tree to generate query responses that may be returned to the authorization system. The query responses may be processed to detect and handle exceptions by returning a second decision logic, a natural language decision logic, with a higher rate of success. By doing so, some of the techniques of the present disclosure may attempt a secure and automated authorization process, without preventing or otherwise hindering an authorization process due to myriad technical challenges with automated queries to different system-specific data sources.

More particularly, some embodiments of the present disclosure provide messaging schemes that leverage communication interfaces between various computing entities within an ecosystem to enable a collaborative authorization process. The communication interfaces may define a plurality of message requests, responses, and updates that enable an authorization system to leverage the security and network infrastructures of other entities within the ecosystem to enforce authorization criteria. For instance, using the communication interfaces, an authorization system may generate a system-specific decisions tree with query logic that is tailored to a particular system-specific data source. The query logic may be created for execution by the query system, on behalf of the authorization system, to indirectly retrieve data that is traditionally inaccessible to the authorization system. By doing so, the authorization and query systems may leverage an automated decision tree to enable the automation of specific authorization tasks that previously could only be performed manually due to data security and network infrastructure constraints.

In some embodiments, the communication interfaces of the present disclosure enable the implementation of a sequential authorization process in which the authorization of a request is automated and exceptions to the automated authorization process are efficiently handled. For example, an authorization system may generate automated decision trees that define query logic tailored to a specific query system with access to a system-specific data source. However, without access to the underlying data queried using the automated decision tree, the performance of the automated decision tree may be subject to numerous exceptions, including incomplete queries resulting in insufficient evidence to authorize a request. These technical challenges may be addressed by performing an automated query-based authorization process as a first stage of a sequential authorization process. In the event of an exception, the sequential authorization process may include a second stage in which the authorization system returns a response with a natural language decision logic to continue the authorization process based on user input. In this manner, the sequential authorization process of the present disclosure may facilitate an automated authorization process that is directly tailored to addressing technical challenges of traditional network-based enforcement mechanisms and may be leveraged to improve both the processing time and efficiency of authorizing secured identifiers relative to the state of the art.

Examples of technologically advantageous embodiments of the present disclosure include: (i) communication interfaces for enabling collaboration between traditionally isolated computing entities within a computing ecosystem, (ii) messaging schemes for enforcing authorization criteria through a sequential authorization process, and (iii) a sequential authorization process for automating an authorization process while efficiently handling exceptions to the automated operations of the process, among other aspects of the present disclosure. Other technical improvements and advantages may be realized by one of ordinary skill in the art.

### V. Example System Operations

As indicated, various embodiments of the present disclosure make important technical contributions to remote authorization technologies that are practically applied to improve the remote authorization processes in traditionally isolated computing ecosystems. In particular, systems and methods are disclosed herein that implement a sequential authorization process to collaboratively generate and then execute automated decision trees across a plurality of traditionally isolated computing entities and data sources within an information domain. The sequential authorization process may further detect and automatically handle exceptions to the automated authorization processing stage of the sequential authorization process. By doing so, a traditionally manual authorization process may be automated without introducing bottlenecks or other performance deficiencies that may inhibit a remote authorization of a secured object. This, in turn, enables query-based authorization techniques to improve the timing, processing resource expenditure, and network connectivity over traditional state of the art systems.

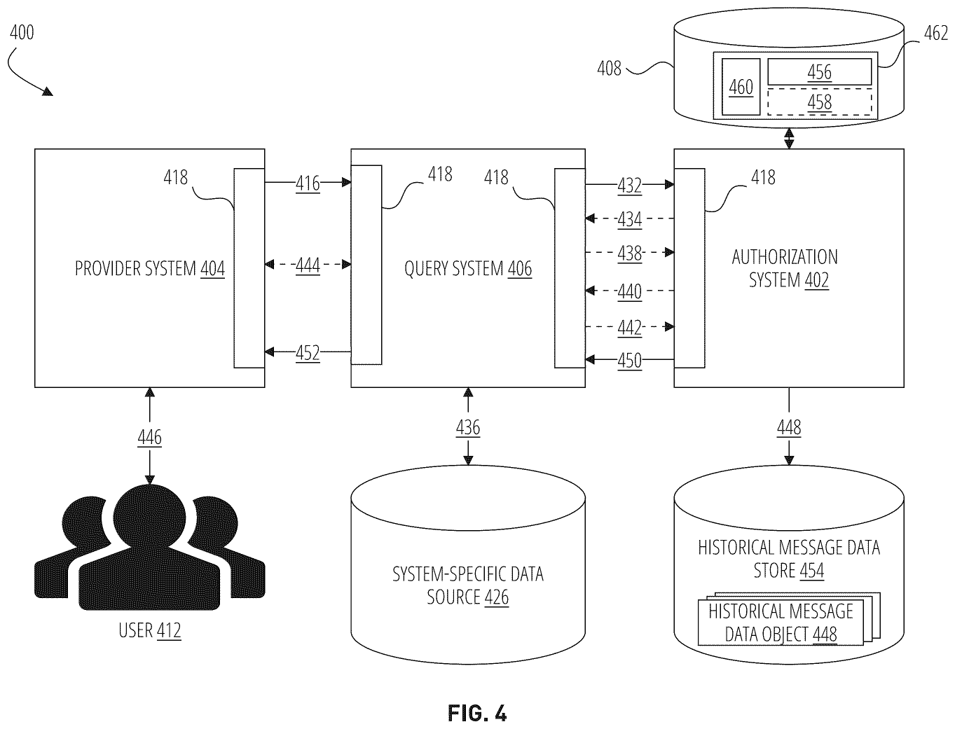

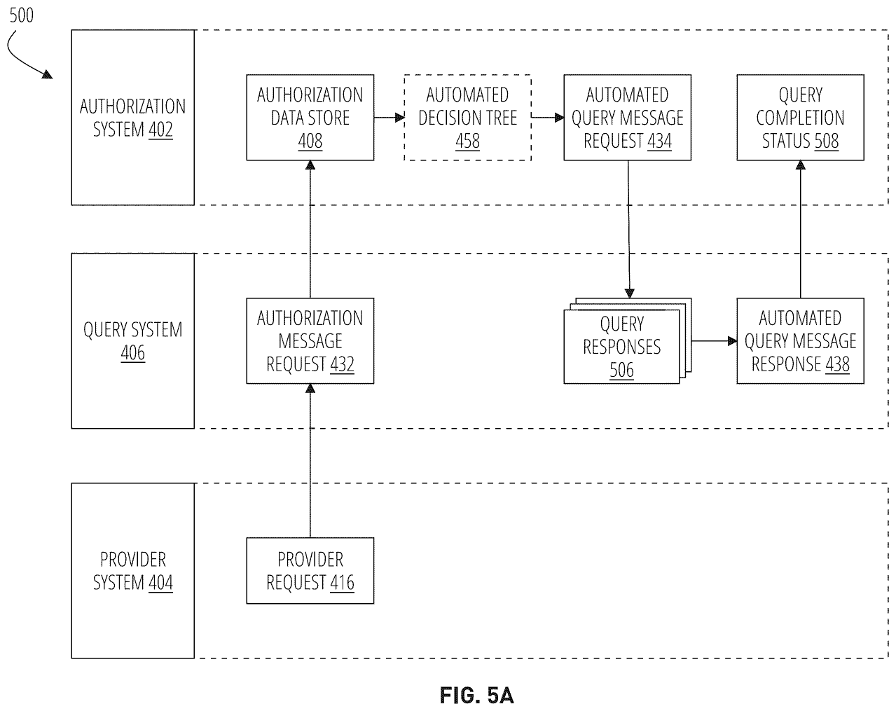

FIG. 4 is an interaction diagram 400 showing example computing entities and messaging schemes for implementing a sequential authorization process in accordance with some embodiments discussed herein. The interaction diagram 400 illustrates interactions between a plurality of computing entities of an authorization computing ecosystem. Through the various communications shown by the interaction diagram 400, the computing entities of the authorization computing ecosystem may implement a multi-stage messaging scheme to automatically perform a sequential authorization process for authorizing secured identifiers that traditionally require manual intervention. Traditional authorization processes for secured identifiers, for example, may require manual intervention due to insufficient network interfaces between entities that govern an authorization process and the data sources with sufficient information to make an authorization decision. As one example, in a clinical information domain, a clinical guideline may be enforced by a medication prescription agency using information from EHRs that are inaccessible to the medication prescription agency due to various data privacy restrictions as well as a lack of network interfaces between the medication prescription agency and the data sources that maintain the EHRs. These technical challenges are traditionally overcome using user input and extensive processing resources for requesting the user input. Using the messaging schemes of the interaction diagram 400, an authorization computing ecosystem may be established for implementing an at least partially automated authorization process through sequential messages across connected computing entities of the authorization computing ecosystem. By doing so, networked authorization processes may be improved to dynamically automate authorization decisions, as illustrated in the interaction diagram 400, which ultimately reduces network communications and processing resources traditionally required to perform a remote authorization.

In some embodiments, the authorization computing ecosystem is an ecosystem of computing entities that are collectively configured to perform an authorization process. An authorization computing ecosystem, for example, may include a plurality of computing entities that are communicatively connected through one or more communication interfaces. The communication interfaces, for example, may include application programming interfaces (APIs), file based interfaces, message queue based interfaces, and/or the like. For instance, a communication interface may include an authorization API 418 including, as examples, one or more simple object access protocol (SOAP) APIs, one or more RPC APIs, one or more WebSocket APIs, one or more REST APIs, and/or the like. In some embodiments, an authorization API 418 may include one or more RPC APIs, such as one or more gRPC APIs.

The computing entities of the authorization computing ecosystem may communicate, via the authorization API 418, to perform a multi-party authorization workflow. The multi-party authorization workflow, for example, may authorize or deny a provider request 416 from an originating computing entity, such as a provider system 404. The request may be authorized or denied through interactions between one or more intermediary computing entities. For example, a first intermediary computing entity, such as a query system 406, may receive and forward a request to a second intermediary computing entity, such as an authorization system 402. The authorization system 402 may interact with the query system 406 to retrieve authorization information from a user and/or one or more system-specific data sources 426 and then provide an authorization response 452, directly or indirectly through the query system 406, to the origination computing entity (e.g., provider system 404). In this manner, an authorization computing ecosystem may facilitate an authorization process through a plurality of entity-to-entity interactions between a plurality of computing entities.

In some embodiments, the communication interfaces include an authorization API 418 that defines a plurality of entity-to-entity messages for facilitating an authorization process. The authorization API 418, for example, may define a plurality of request, response, and/or update messages that enable each of the computing entities within the authorization computing ecosystem to interact with each other to perform one or more authorization operations. The authorization API 418 may provide flexibility to an authorization system 402 that allows the authorization system 402 to interact with a plurality of query systems 406 respectively connected with a plurality of disparate, system-specific data sources 426. By doing so, a central authorization system 402 of an authorization computing ecosystem may enforce, facilitate, and, in some cases, automate authorization decisions for a plurality of provider systems 404 and query systems 406.

In some embodiments, a query system 406 is a computing entity of an authorization computing ecosystem. The query system 406, for example, may include a computing system, platform, and/or device that is configured to perform one or more operations of the present disclosure to initiate a query to one or more system-specific data sources 426. In some examples, the query system 406 may include an intermediary system between a provider system 404 and an authorization system 402. The query system 406, for example, may forward and return messages between a provider system 404 and an authorization system 402 to facilitate an authorization of a provider request 416 for a provider system 404 in accordance with one or more authorization criteria enforced by the authorization system 402.

In some embodiments, the query system 406 is integrated, through one or more query APIs, with one or more system-specific data sources 426. For example, the query system 406 may have access to query APIs with the system-specific data source 426 that enables retrieval of information from the system-specific data source 426. In some examples, the query system 406 may leverage the one or more query APIs, and/or one or more other pre-established connections, to perform a query on behalf of an authorization system 402. For example, the query system 406 may receive query logic from an authorization system 402 and execute the query logic to perform a query to the system-specific data source 426.

In some embodiments, the system-specific data source 426 is a data storage entity configured to store, maintain, and/or monitor a data catalog. For example, the system-specific data source 426 may include a heterogenous data store that is configured to store a data catalog using specific database technologies, such as Netezza, Teradata, and/or the like. A system-specific data source 426, for example, may include a data repository, such as a database, and/or the like, for persistently storing and managing collections of structured and/or unstructured data (e.g., catalogs, etc.). In some examples, the system-specific data source 426, and/or a data catalog thereof, may include sensitive information that is stored in compliance with one or more security measures. By way of example, in a clinical information domain, the system-specific data source 426 may include a plurality of EHRs for subscribing patients of a particular health institution. In such a case, the system-specific data source 426 may include robust data governance protocols for accessing, retrieving, and/or initiating queries to a data catalog. In some examples, the data governance protocols may establish one or more approved querying entities, which may include the query system 406.

In some embodiments, the provider system 404 is a computing entity of an authorization computing ecosystem. The provider system 404, for example, may include a computing system, platform, and/or device that is configured to perform one or more operations of the present disclosure to initiate an authorization message request 432 that may require an authorization process. In this regard, the provider system 404 may include any system that provides a provider request 416 to initiate an authorization message request 432 between a query system 406 and an authorization system 402. A provider system 404 may be different depending on the information domain. As one example, in a clinical information domain, the provider system 404 may include a clinical system owned, operated, and/or the like by a clinical provider. For instance, a provider system 404 may be interacted with by a user 412, such as a clinical provider, to provide a prior authorization request to an authorization system 402 (e.g., through the query system 406).

In some examples, the provider system 404 may facilitate one or more user interactions to perform one or more portions of an authorization process. For example, the provider system 404 may include one or more client devices, with one or more input/output elements, configured to receive user input (e.g., via one or more keyboards, touchpads, etc.) and provide user interpretable information (e.g., via a display, speaker, etc.) to a user 412. The user input, for example, may be received by the provider system 404 and used to initiate an authorization message request 432 and/or interact with a natural language decision logic to facilitate an authorization message response 450.

In some embodiments, an authorization system 402 is a computing entity of an authorization computing ecosystem. The authorization system 402, for example, may include a computing system, platform, and/or device that is configured to perform one or more operations of the present disclosure to enforce, facilitate, and/or otherwise engage in an authorization process. For instance, the authorization system 402 may be configured to generate, store, and/or communicate one or more decision logics that are tailored to a particular predictive response. The decision logic, for example, may include an automated decision tree 458 and/or natural language decision logic 456 for a particular predictive response. The decision logic may depend on an information domain. As one example, continuing the clinical information domain example herein, the decision logic may correspond to criteria for a prior authorization decision with respect to a particular clinical service, such as a medication prescription, and/or the like.

In some embodiments, the authorization system 402 generates one or more decision logics from platform criteria that define restrictions to a predictive response. In a clinical domain, the platform criteria, for example, may include clinical guidelines established by a medication prescriber. The authorization system 402 may enforce, facilitate, and/or otherwise engage in an authorization process by initiating queries to one or more query systems 406 in accordance with the one or more decision logics and, in response to query responses for the initiated queries, determine and provide an authorization response 452 to a provider system 404.

In some embodiments, the authorization data store 408 is a data structure that describes a plurality of authorization data objects 462 respectively corresponding to a plurality of secured identifiers 460 of an information domain. An example authorization data store 408 may include any type (and any number) of data storage structures including, as examples, one or more linked lists, databases (e.g., relational databases, graph database, etc.), and/or the like. In some embodiments, an authorization data store 408 may include a plurality of authorization data objects 462, each reflective of a secured identifier 460 and one or more decision logics corresponding to the secured identifier 460. In addition, or alternatively, an authorization historical message data object 448 may include a source document and/or a reference (e.g., a source identifier) to a source document.

In some examples, a source document includes structured and/or natural language text that describes criteria for authorizing an action with respect to a particular secured identifier 460. A secured identifier 460, for example, may correspond to a service, product, data, and/or any other tangible or intangible item that may be subject to one or more authorization criteria. By way of example, in a clinical prior authorization process, a secured identifier 460 may correspond to a clinical service, prescription, and/or the like that is subject to one or more regulatory-, insurance-, and/or health-related restrictions. In any information domain, one or more restrictions, or “authorization criteria,” may be established for a secured identifier 460 through one or more source documents.

In some examples, a source document may include natural language text that is uninterpretable to a computer and potentially misleading during manual review. To improve the efficiency of an authorization process, one or more decision logics may be generated from a source document. The one or more decision logics may include one or more decision trees, and/or any other data structure, that separates criteria from a source document into a plurality of single question-answer units. For example, the one or more decision logics may include a natural language decision logic 456 and/or an automated decision tree 458. In some examples, each of the authorization data objects 462 may include a natural language decision logic 456. In addition, or alternatively, one or more of the authorization data objects 462 may be augmented with an automated decision tree 458. In some examples, the natural language decision logic 456 and/or the automated decision tree 458 may be automatically and individually generated, using one or more natural language processing (NLP) techniques from a source document (e.g., natural language clinical guidelines in a clinical domain, etc.).

In some examples, the generation of an automated decision tree 458 may leverage additional upfront processing resources compared to natural language decision logic 456 to conserve processing resources during the execution of downstream authorization processes. To optimize computing resource usage, an automated decision tree 458 may be generated for a set of automated identifiers filtered from a plurality of secured identifiers 460 of the information domain. In some examples, the set of automated identifiers may be filtered based on a frequency of use. For example, the set of automated identifiers may be identified based on a frequency of use across a plurality of historical data objects for the information domain. The historical data objects, for example, may include a plurality of historical authorization message requests, a plurality of historical user interactions, and/or the like. By way of example, in a clinical information domain, the set of automated identifiers may be identified based on historical drug prescription frequencies for a particular provider and/or a cohort of providers.

In some examples, an authorization data object 462 that includes an automated decision tree 458 may be flagged with an automation indicator. For instance, an automation indicator may be stored in the authorization data object 462. In addition, or alternatively, a secured identifier 460 of the authorization data object 462 may be stored with an automation indicator. In some examples, a plurality of automation indicators, respectively corresponding to a plurality of secured identifiers, may be provided to one or more computing entities, such as the query system 406, of an authorization computing ecosystem. In some examples, the query system may store (e.g., in an automation lookup table, etc.) the secured identifiers and corresponding automation indicators for use in providing an authorization message request 432 to the authorization system 402 of the authorization computing ecosystem.

Each of the elements of an authorization data object 462 may depend on an information domain and may apply to any information domain in which access to a service, product, and/or the like is restricted in accordance with one or more criteria. By way of example, using a clinical information domain as an example, a secured identifier 460 may correspond to a drug prescription, a source document may correspond to clinical guideline documentation for the drug prescription, and the decision logic sets may correspond to structured rules extracted from the clinical guideline documentation for authorizing the drug prescription. The structured rules, for example, may be extracted as a natural language decision logic 456 that may be resolved by a clinical professional or an automated decision tree 458 that may be resolved through queries to an EHR system accessible to a query system 406. As described herein, the decision logics may be intelligently surfaced to a query system 406 during a sequential authorization process to conserve computing resources while completing a prior authorization request for a drug prescription.

In some embodiments, an authorization message request 432 is received by an authorization system 402. The authorization message request 432 may include an automation indicator. In some examples, the authorization message request 432 may be received from the query system 406.

In some embodiments, the authorization message request 432 is a data entity that defines a request to perform an authorization for a secured identifier 460. An authorization message request 432 may be provided to the authorization system 402 from a requesting system, such as the provider system 404, the query system 406, and/or the like of the authorization computing ecosystem. The authorization message request 432 may include one or more authorization parameters. The one or more authorization parameters may include a secured identifier 460, an authorization indicator, an entity identifier, a requesting system identifier, and/or the like. An entity identifier, for example, may include a numeric, alpha-numeric, and/or any other value that identifies a particular entity within an information domain. By way of example, in a clinical information domain, an entity may be a member for which a clinical service, prescription, and/or the like is requested.

In some examples, a message format of the authorization message request 432 may be defined by the authorization API 418. For example, the authorization message request 432 may include a predefined call between the query system 406 and the authorization system 402. In this way, the authorization system 402 may receive, from the query system 406, the authorization message request 432 including one or more authorization parameters, such as a secured identifier 460, an authorization indicator, and/or any other parameter defined by a message format of the authorization message request 432. The authorization system 402 may receive the authorization message request 432 and respond with an authorization message response 450 for the secured identifier 460 of the authorization message request 432. In some examples, the authorization message response 450 may be based on one or more intermediate communications between the entities of the authorization computing ecosystem.

In some embodiments, an automation indicator is identified from the authorization message request 432. For example, the authorization system 402 may identify the automation indicator. In response to identifying the automation indicator, an automated decision tree 458 corresponding to the automation indicator may be identified and an automated query message request 434 including the automated decision tree 458 may be provided to a query system 406. In some examples, the automated query message request 434 may include an executable file including the automated decision tree 458. In addition, or alternatively, the automated query message request 434 may include a reference, such as an executable link, a shared file location, and/or the like, to the automated decision tree 458. In some examples, the query system 406 may be configured to perform one or more conditional queries 436 within a system-specific data source 426 in accordance with the automated decision tree 458. The automated query message request 434 may be provided to the query system 406 to perform the one or more conditional queries 436 based on the automated decision tree 458 on behalf of the authorization system 402.

In some embodiments, an automated query message request is a data entity that defines an intermediate request to perform an automated query operation for an authorization process. The automated query message request 434 may be provided to the query system 406 from the authorization system 402 in response to the authorization message request 432. The automated query message request 434 may include one or more query parameters. The one or more query parameters may reflect the automated decision tree 458 and/or one or more portions thereof. In some examples, the one or more query parameters may identify the automated decision tree 458 that defines one or more query operations on behalf of an entity and the secured identifier 460 of the authorization message request 432. By way of example, the automated query message request 434 may include a plurality of conditional queries 436 and an entity identifier on which to perform one or more queries in accordance with the conditional queries 436. The query, for example, may be performed on one or more entity data objects within a system-specific data source 426 (e.g., EHRs for a patient in a clinical information domain, etc.).

In some examples, a message format of the automated query message request 434 may be defined by the authorization API 418. For example, the automated query message request 434 may include a predefined call between the query system 406 and the authorization system 402. In this way, the authorization system 402 may provide, to the query system 406, the automated query message request 434 including one or more instructions to perform queries to the system-specific data source 426 to facilitate an authorization process. The query system 406 may receive the automated query message request 434, perform one or more queries in accordance with the automated query message request 434 (e.g., an automated decision tree 458 thereof, etc.), and respond with the automated query message response 438 for a secured identifier 460 and entity of the automated query message request 434.

In some embodiments, an automated query message response 438 is received in response to the automated query message request 434. For example, the authorization system 402 may receive the automated query message response 438 from the query system 406. The automated query message response 438 may include a sequence of query responses corresponding to one or more query branches of the automated decision tree 458.

In some embodiments, an automated query message response 438 is a data entity that defines an intermediate response reflective of a performance of one or more query operations for an authorization process. The automated query message response 438 may be provided to the authorization system 402 from the query system 406 in response to the automated query message request 434. The automated query message response 438 may include one or more query response parameters. The one or more query response parameters may reflect one or more query responses to one or more conditional queries 436 of the automated query message request 434. In some examples, the one or more query response parameters may identify a sequence of query responses corresponding to one or more branches of an automated decision tree 458. For example, the authorization system 402 may receive, from the query system 406, the automated query message response 438 including a sequence of query responses that at least partially complete at least one branch of an automated decision tree 458. In some examples, each query response may include a data element, data value, data source, and/or any other metadata associated with a query to a system-specific data source 426 that is performed by executing query logic of a conditional query 436.

In some examples, a message format of the automated query message response 438 may be defined by the authorization API 418. For example, the automated query message response 438 may include a predefined call between the query system 406 and the authorization system 402. In this way, the query system 406 may provide, to the authorization system 402, the automated query message response 438 including one or more query responses retrieved responsive to the automated query message request 434. The authorization system 402 may receive the automated query message response 438, perform an authorization process based on the one or more query responses, and respond with the authorization message request 432 and/or another intermediate communication in accordance with the authorization process.

In some embodiments, a query completion status of the automated query message response 438 is determined based on the sequence of query responses. In response to the query completion status identifying an incomplete query response, a user query message request 440 may be provided to a query system 406. For example, a natural language decision logic 456 may be identified that corresponds to the automated decision tree 458. The user query message request 440 may be provided to the query system 406 that includes the natural language decision logic 456 and/or one or more portions thereof.

In some embodiments, the user query message request 440 is a data entity that defines an intermediate request to perform a user query operation for an authorization process. The user query message request 440 may be provided to the query system 406 (and/or another requesting system, such as the provider system 404) from the authorization system in response to an incomplete query response (or an absence of an automation indicator). The user query message request 440 may include one or more user query parameters. The one or more user query parameters may reflect a natural language decision logic 456 and/or one or more portions thereof for a secured identifier 460. In some examples, the one or more user query parameters may identify the natural language decision logic 456 that defines one or more conditional statements on behalf of an entity and the secured identifier 460 of the authorization message request 432. By way of example, the user query message request 440 may include a plurality of conditional statements 444 and an entity identifier for which to provide one or more prompts in accordance with the conditional statements 444. The prompt, for example, may be provided, via the query system 406 and/or provider system 404, to a user to request user input. The user input may include a user response to a conditional statement 444 that may be used, with the natural language decision logic 456, to generate a subsequent prompt for a user until the natural language decision logic 456 terminates with a predictive response for the secured identifier 460.

In some examples, a message format of the user query message request 440 may be defined by the authorization API 418. For example, the user query message request 440 may include a predefined call between the authorization system 402 and a requesting system (e.g., the query system 406, provider system 404, etc.). In this way, the authorization system 402 may provide, to a requesting system, the user query message request 440 including one or more instructions to provide a sequence of user prompts to facilitate an authorization process. In some examples, the user query message request 440 may be provided as a secondary, less efficient, authorization process in the event that the automated decision tree 458 is not defined for a secured identifier 460 and/or a query completion status reflects an incomplete query response for the automated decision tree 458 of a secured identifier 460. In some examples, in response to an incomplete query response (or absence of an automated decision tree 458), the authorization system 402 may identify the natural language decision logic 456 for a secured identifier 460, generate the user query message request 440 with the natural language decision logic 456 (and/or a reference to the natural language decision logic 456), and provide the user query message request 440 to a requesting system. The requesting system may receive the user query message request 440, provide one or more user prompts in accordance with the user query message request 440 (e.g., the natural language decision logic 456 thereof, etc.), and respond with a user query message response 442 for the secured identifier 460 and an entity of the user query message request 440.

In some embodiments, a user query message response 442 is received in response to the user query message request 440. For example, the authorization system 402 may receive the user query message response 442 from the query system 406. The user query message response 442 may include a sequence of user responses corresponding to one or more statement branches of the natural language decision logic 456.

In some embodiments, the user query message response 442 is a data entity that defines an intermediate response reflective of a performance of one or more prompt operations for an authorization process. The user query message response 442 may be provided to the authorization system 402 from a requesting system in response to the user query message request 440. The user query message response 442 may include one or more prompt response parameters. The one or more prompt response parameters may reflect one or more user responses to one or more conditional statements 444 of the user query message request 440. In some examples, the one or more user response parameters may identify a sequence of user responses corresponding to one or more branches of the natural language decision logic 456. For example, the authorization system 402 may receive, from the requesting system, the user query message response 442 including a sequence of user responses that at least partially complete at least one sequence of conditional statements 444 from the natural language decision logic 456. In some examples, each user response may include a data element, data value, and/or any other metadata associated with user input from a user provided in response to a prompt defined by a conditional statement 444.

In some examples, a message format of the user query message response 442 may be defined by the authorization API 418. For example, the user query message response 442 may include a predefined call between a requesting system and the authorization system 402. In this way, the requesting system may provide, to the authorization system 402, the user query message response 442 including one or more user responses retrieved responsive to the user query message request 440. The authorization system 402 may receive the user query message response 442, perform an authorization process based on the one or more user responses, and respond with the authorization message request 432 in accordance with the authorization process.

In response to the query completion status identifying a complete query response, an authorization message response 450 may be provided to a query system 406. In some embodiments, the authorization message response 450 is a data entity that defines a response reflective of an authorization for the secured identifier 460. The authorization message response 450 may be provided to a requesting system from the authorization system 402 in response to the authorization message request 432. The authorization message response 450 may include one or more authorization response parameters. The one or more authorization response parameters may include a secured identifier, an entity identifier, a predictive response, textual response explanation, and/or the like.

In some examples, a message format of an authorization message response 450 may be defined by the authorization API 418. For example, the authorization message response 450 may include a predefined call between the query system 406 and the authorization system 402. In this way, the authorization system 402 may provide, to the query system 406, the authorization message response 450 including one or more authorization response parameters, such as the predictive response and/or the textual response explanation for a secured identifier 460 of the authorization message request 432. The authorization system 402 may provide the authorization message response 450 based on an authorization process performed in response to the authorization message request 432.

In some examples, the authorization message response 450 may include a predictive response that describes an authorization resolution for a secured identifier 460 with respect to an entity. In addition, the authorization message response 450 may include a textual response explanation that reflects a short reasoning statement for the authorization resolution. In some examples, the predictive response may be determined, by the authorization system 402, based on a completed branch of a decision logic, such as a query branch of the automated decision tree 458 and/or the like.

In some examples, a predictive response and/or a textual response explanation may be determined based on one or more responses to a sequence of conditional statements (e.g., from a natural language decision logic 456, etc.) and/or to a sequence of conditional queries (e.g., from an automated decision tree 458, etc.). In some examples, the authorization message response 450 may include a response message identifier. The response message identifier, for example, may include a numeric, alpha-numeric, and/or like value that identifies the authorization message response 450. In some examples, a response message identifier may be stored with a predictive response, a textual response explanation, and/or one or more responses (e.g., user responses, query responses, etc.) to a sequence of conditional statements 444 and/or conditional queries 436. For example, the response message identifier and corresponding data may be stored as a historical message data object 448 of a historical message data store 454.

In some embodiments, the predictive response, the textual response explanation, and the sequence of query responses of an authorization message response 450 are stored in association with a response message identifier corresponding to the authorization message response 450. For example, the data may be stored as a historical message data object 448 of a historical message data store 454.

In some embodiments, the historical message data store 454 is a data structure that describes a plurality of historical message data objects 448 for an information domain. An example historical message data store 454 may include any type (and any number) of data storage structures including, as examples, one or more linked lists, databases (e.g., relational databases, graph database, etc.), and/or the like. In some embodiments, the historical message data store 454 may include a plurality of historical message data objects 448, each reflective of a response message identifier, a predictive response, a textual response explanation, and/or one or more responses (e.g., user responses, query responses, etc.) to a sequence of conditional statements and/or queries.

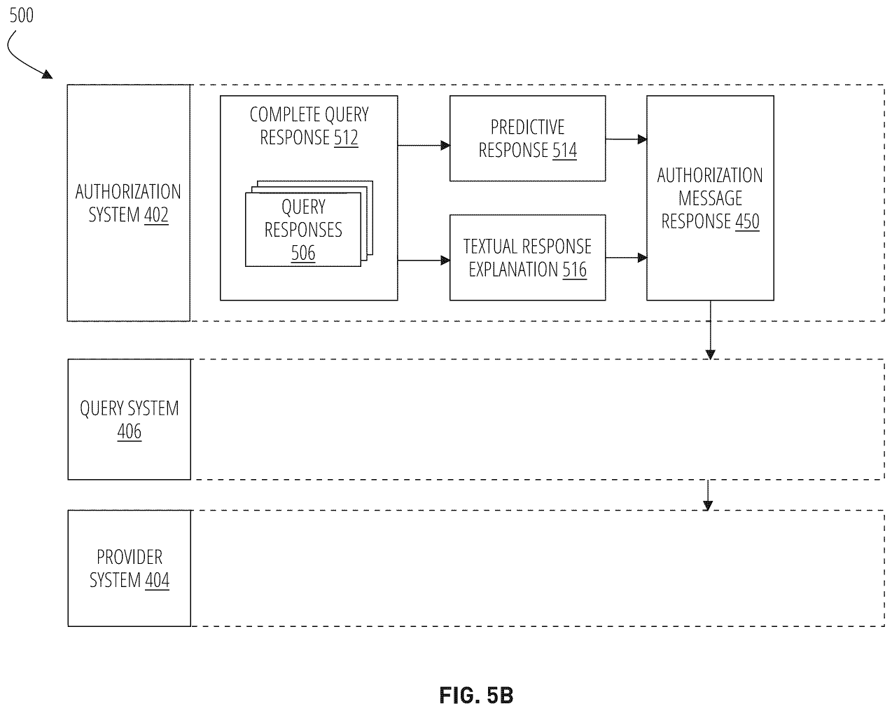

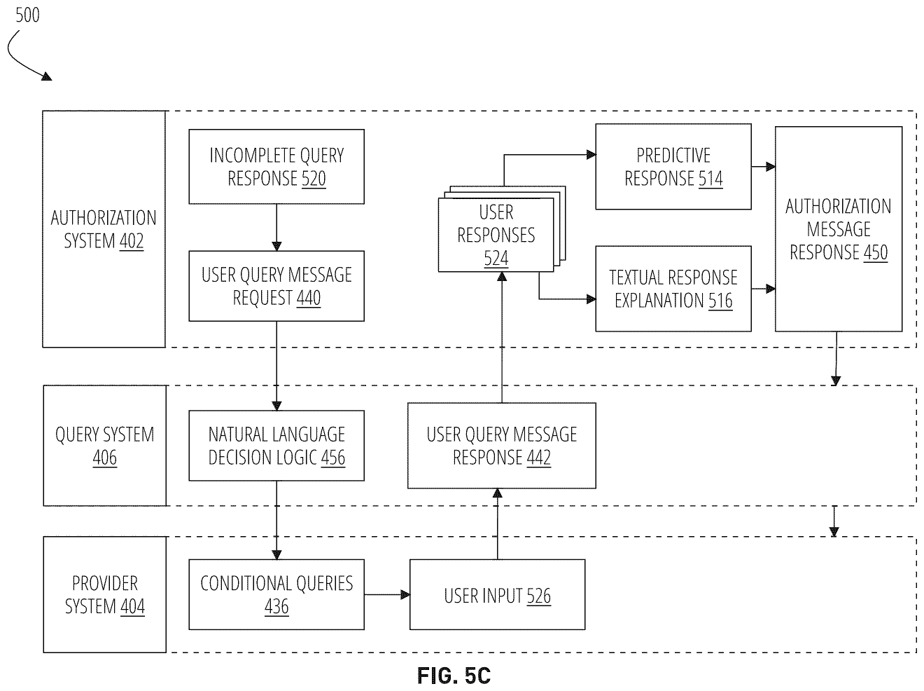

In this manner, a messaging scheme may define a plurality of interactions between a plurality of computing entities within an authorization computing ecosystem to efficiently determine an authorization response 452 for a provider request 416. The sequential authorization process enabled by the messaging scheme may optimize the use of processing resources and reduce network traffic by selectively leveraging automation capabilities through multi-party interactions that are traditionally unavailable in various networked environments. As described herein, the automation capabilities may be selectively leveraged using various data structures generated, modified, and processed throughout the sequential authorization process. These data structures are described in further detail with reference to FIGS. 5A-C.

FIGS. 5A-C is a dataflow diagram 500 showing example data structures and modules for implementing a sequential authorization process in accordance with some embodiments discussed herein. The dataflow diagram 500 include a specific set of a plurality of data structures that form a multi-stage message filtering scheme for selectively automating one or more portions of a sequential authorization process. For example, the sequential authorization process may leverage a plurality of automated decision trees 458 to automate an intermediate query process for one or more automated identifiers of a plurality of secured identifiers 460 within an information domain. The intermediate query process may depend on information inaccessible to the authorization system 402 that defines the automated decision trees 458. To enable automation, without introducing bottlenecks or performance deficiencies to a traditionally manual authorization process, the sequential authorization process filters messages based on capability of automation and success of an automated task. By doing so, the automation may be enabled while efficiently handling exceptions to the automation process.

FIG. 5A includes a first portion of the dataflow diagram 500 that depicts an initial stage of a sequential authorization process. In some embodiments, the sequential authorization process is initiated by a provider request 416 from a provider system 404. In response to the provider request 416, a query system 406 may generate and provide an authorization message request 432 to the authorization system 402. In some examples, the authorization message request 432 may include an automation indicator and/or a secured identifier 460. In some examples, the automation indicator may be previously provided to the query system 406 to identify an automated decision tree 458 from an authorization data store 408.

In some embodiments, an automation indicator is a data parameter that describes an automated capability of an authorization process with respect to a secured identifier. For example, an automation indicator may include a request field, such as a request flag, and/or the like, of a request message, such as an authorization message request 432. In some examples, the automation indicator may include a binary value that indicates whether a secured identifier of an authorization message request 432 corresponds to an automated decision tree 458 (e.g., as indicated by a lookup table, etc., periodically updated via communication with the authorization system 402). In addition, or alternatively, the automation indicator may include a lookup key, and/or another numeric, alpha-numeric, and/or like value that may correspond (e.g., match, etc.) a unique identifier of an automated decision tree 458. By way of example, an automation indicator, and/or other data indicative of the automated decision tree 458 for a secured identifier, may be provided to a requesting system, such as a query system 406 and/or provider system 404, via one or more periodic update messages from the authorization system 402. The automation indicator, and/or other data indicative of the automated decision tree 458 for a secured identifier, may be stored in a lookup table and/or any other accessible data structure for generating the authorization message request 432 for a secured identifier.

In some embodiments, an automated decision tree 458 is identified from the authorization data store 408 in response to the automation indicator. The automated decision tree 458 may include a plurality of query branches. A query branch of the plurality of query branches may include a plurality of nodes respectively corresponding to a plurality of conditional queries to the system-specific data source. By way of example, the automated decision tree 458 may include a plurality of query branches. Each query branch of the plurality of query branches may include a plurality of nodes and may terminate at a terminal node that reflects a particular predictive response for a provider request 416. Each node of the plurality of nodes may include (a) query logic for performing a query and (b) routing logic for transitioning from the node to a subsequent node of the automated decision tree 458 based on a query response to the query.

In some embodiments, an automated decision tree 458 is a data structure that includes one or more logic statements, each describing a computer-interpretable query for a secured identifier. In some examples, the automated decision tree 458 may include a plurality of conditional queries. Each conditional query may include a query and a conditional logic for moving to a subsequent conditional query of the automated decision tree 458. In some examples, a query of a conditional query may include query logic for initiating a query to a system-specific data source. The query logic, for example, may be executable by the query system 406 to initiate a query to a system-specific data source 426 and, in response to the query, receive a query response 506 from the system-specific data source. The query logic, for example, may include an executable instruction for retrieving a particular data value type from a record accessible to the query system 406. A conditional logic of the conditional query may define an action in response to the query response. The action, for example, may define a subsequent conditional query of the automated decision tree 458. The automated decision tree 458 may terminate with a predictive response 514 for a secured identifier.

In some embodiments, the automated decision tree 458 includes a decision tree structure with a plurality of linked nodes. For example, the automated decision tree 458 may include a plurality of query branches. Each query branch may include one or more connected nodes that begin at start node and end at a terminating node. Each of the query branches may terminate at a terminal node that reflects a particular predictive response for a secured identifier. For example, for a binary authorization response, each of the query branches may terminate at an authorized node or an unauthorized node.

In some examples, each node of the automated decision tree 458 may correspond to a conditional query. For instance, each node may include a query logic for executing a query of a conditional query and routing logic for executing a conditional logic of the conditional query. The routing logic, for example, may include an executable instruction for routing from a current node to a subsequent node in the automated decision tree 458 based on a query response 506 to the query logic. In some examples, the routing logic for each node may require a query response 506 to traverse from the node to a subsequent node. In this manner, each branch of an automated decision tree 458 may define a plurality of queries that require answers to reach a predictive response 514.

In some examples, an automated decision tree may correspond to an automation indicator and/or a secured identifier associated with an automation indicator. For example, an automated decision tree may be stored in association with an automation indicator and/or secured identifier (e.g., in an authorization data object, etc.). In this manner, an automated decision tree may be identified in response to an automation indicator and/or a secured identifier of an authorization message request. In some examples, an automated decision tree may be identified and provided in response to an automation indicator of an authorization message request.

In some embodiments, an automated query message request 434 is generated that includes and/or references the automated decision tree 458, as described herein. The automated query message request 434 may be provided, by the authorization system 402, to the query system 406. The query system 406 may execute one or more conditional queries 436 in accordance with the automated decision tree 458 to generate a sequence of query responses 506. The sequence of query responses 506, for example, may include one or more query responses respectively corresponding to one or more of the plurality of nodes of the automated decision tree 458. In some examples, the query system 406 may generate an automated query message response 438 that includes and/or references the sequence of query responses 506 and provides the automated query message response 438 to the authorization system 402.

In some embodiments, the authorization system 402 receives the automated query message response 438 and determines a query completion status 508 based on the sequence of query responses 506. The query completion status 508, for example, may identify a complete query response 512 and/or an incomplete query response 520. A complete query response 512 may indicate that the sequence of query responses 506 terminates at the terminal node of an automated decision tree 458. An incomplete query response 520 indicates that the sequence of query responses 506 terminates at one or more intermediate nodes preceding a terminal node of the automated decision tree 458.

In some embodiments, the query completion status 508 is a data element that describes a state of an authorization process responsive to an automated query message response 438. A query completion status 508, for example, may reflect a proportion of a plurality of conditional queries that are executed in response to an automated query message request 434. For instance, a query completion status 508 may reflect a complete query response 512 and/or an incomplete query response 520 to at least a portion of the plurality of conditional queries. A complete query response 512 may reflect that a sequence of query responses 506 from an automated query message response 438 completes a branch of an automated decision tree 458. An incomplete query response 520 may reflect that a sequence of query responses 506 from an automated query message response 438 does not complete a branch of an automated decision tree 458. By way of example, a complete query response 512 may reflect that a sequence of query responses 506 reaches a terminal node of an automated decision tree 458, whereas an incomplete query response 520 may reflect that a sequence of query responses 506 terminates at one or more intermediate nodes preceding a terminal node of the automated decision tree 458.

In some examples, the authorization system 402 may assign a query completion status 508 based on a comparison between one or more query responses 506 of an automated query message response 438 and the automated decision tree 458 corresponding to a secured identifier. For example, the query completion status 508 may be determined based on a determination of whether the automated query message response 438 includes one or more query responses 506 that reach a terminal node of an automated decision tree 458. In some examples, the authorization system 402 may respond to the automated query message response 438 with a different message based on a query completion status 508. For example, the authorization system 402 may respond with an authorization message response 450 in response to a complete query response 512 as shown in FIG. 5B. In addition, or alternatively, the authorization system 402 may respond with a user query message request 440 in response to an incomplete query response 520 as shown in FIG. 5C.

By way of example, in response to a complete query response 512, the authorization system 402 may generate an authorization message response 450 as shown by FIG. 5B. The authorization message response 450 may include a predictive response 514 and/or a textual response explanation 516. The predictive response 514 may be based on the sequence of query responses 506. For example, in response to the query completion status 508 identifying the complete query response 512, the authorization system 402 may determine the predictive response 514 based on a terminal node of the automated decision tree 458. In addition, or alternatively, the authorization system 402 may determine a textual response explanation 516 for the predictive response 514 based on the sequence of query responses 506.

In some embodiments, the predictive response 514 is a data entity that describes an authorization resolution for a secured identifier with respect to an entity. A predictive response 514, for example, may include a multi-class response that is one of a plurality of categories of authorization. Each authorization category, for example, may define one or more conditions of an authorization for a secured identifier. In addition, or alternatively, the predictive response 514 may include a binary response that is either an authorized response indicating that a secured identifier is authorized for an entity or an unauthorized response indicating that a secured identifier is not authorized for an entity. In some examples, the predictive response 514 may be identified from a terminal node or terminal statement of a decision logic for a secured identifier.

In some embodiments, a textual response explanation 516 is a data entity that describes a reasoning for an authorization resolution. A textual response explanation 516, for example, may include a sequence of text that describes one or more responses that contributed to a predictive response 514. By way of example, a textual response explanation 516 may include a text summary of one or more query responses 506 and/or user responses 524 that resulted in a predictive response 514.

In some examples, the textual response explanation 516 may include an extractive or abstractive summary of the one or more query responses 506 and/or user responses 524. For example, the textual response explanation 516 may be generated, using one or more NLP summarization techniques, based on the one or more query responses 506 and/or user responses 524. In addition, or alternatively, the textual response explanation 516 may include a generative text summary of the one or more query responses 506 and/or user responses 524. For example, the textual response explanation 516 may by generated, using a generative model, such as an LLM, and/or the like. The LLM, for example, may include a GPT model and/or any other machine learning model with generative capabilities. In some examples, the textual response explanation 516 may be generated by inputting a generative prompt (e.g., a no shot prompt, few shot prompt, etc.) that includes the one or more query responses 506 and/or user responses 524 to the generative model.

In response to an incomplete query response 520, the authorization system 402 may generate a user query message request 440 as shown by FIG. 5C. The interaction diagram 400 may include natural language decision logic 456 for performing one or more user prompts 446. For example, in response to the query completion status 508 identifying an incomplete query response 520, the authorization system 402 may identify a natural language decision logic 456 corresponding to the automated decision tree 458 and provide a user query message request 440 including the natural language decision logic 456 to the query system 406.

In some embodiments, the natural language decision logic 456 is a data structure that includes one or more logic statements, each describing a natural language question for a secured identifier. In some examples, the natural language decision logic 456 may include a plurality of conditional statements. Each conditional statement may include a prompt and a conditional logic for moving to a subsequent conditional statement of the natural language decision logic 456. In some examples, a prompt of a conditional statement may include natural language text that may be provided to a user to prompt user input in response to the conditional statement. A conditional logic of the conditional statement may define an action in response to a user input 526. The action, for example, may define a subsequent conditional statement of the natural language decision logic 456. The natural language decision logic 456 may terminate with a predictive response 514 for a secured identifier.

In some embodiments, the natural language decision logic 456 is derived from a source document that defines criteria for a response with respect to a secured identifier. For example, the criteria may include one or more conditions for authorizing a secured identifier. In some examples, a natural language decision logic 456 may include one or more conditional statements for each of the one or more conditions defined by the source document. In this manner, a natural language decision logic 456 may define a sequence of interactive natural language prompts to sequentially collect information for determining a response for a secured identifier in accordance with criteria defined for the secured identifier. In this way, a natural language decision logic 456 may break down a source document into a series of easily consumable questions that may be efficiently surfaced to a user. However, the questions are specific to users and are uninterpretable to a query system 406 making natural language decision logic 456 unable to support automated queries to data sources, other than users, that may be capable of answering a question without user input.

In response to the user query message request 440, the query system 406 may surface conditional queries 436 of the natural language decision logic 456 to a user (e.g., via a provider system 404). The user may provide a user input 526 in response to the conditional queries 436. The user input 526 may be provided to the query system 406 to generate a user query message response 442 with a plurality of user responses 524. The user query message response 442 may be provided to the authorization system 402 and the authorization system 402 may process the plurality of user responses 524 to generate a predictive response 514 and/or textual response explanation 516 for an authorization message response 450. The authorization message response 450 may then be provided to the query system 406 and/or provider system 404 to complete the sequential authorization process in the event of an exception to an automated decision tree 458.

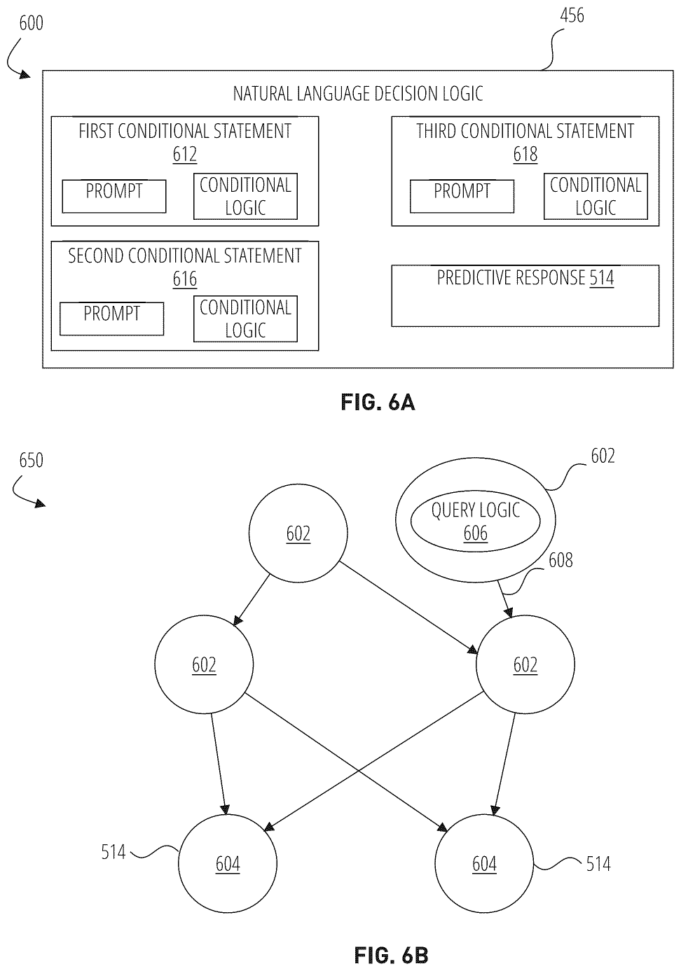

FIGS. 6A-B are operational examples of decision logics in accordance with some embodiments discussed herein.

FIG. 6A is an operational example 600 of a natural language decision logic 456. As shown, the natural language decision logic 456 may include a plurality of conditional statements, including a first conditional statement 612, a second conditional statement 616, and a third conditional statement 618. Each of the conditional statements may include a prompt and conditional logic for moving from a conditional statement to a subsequent conditional statement of the natural language decision logic 456. The natural language decision logic 456 may terminate with a predictive response 514 (e.g., an authorization decision, etc.) for an authorization process.

FIG. 6B is an operational example 650 of an automated decision tree 458. As shown, the automated decision tree 458 may include a plurality of nodes, including one or more intermediate nodes 602 and one or more terminating nodes 604. Each of the intermediate nodes 602 may include query logic 606 that defines query requirements for executing a query to a system-specific data source. The plurality of nodes may be connected by routing logic 608 that defines a conditional path from one node to a subsequent node based on a query result to the query logic 606 of the respective node. The automated decision tree 458 may terminate at one or more terminating nodes 604 that may respectively correspond to one or more predictive responses 514 for an authorization process. In some examples, the automated decision tree 458 may include a plurality of query branches that each define a path from a start node to one of the terminating nodes 604 of the automated decision tree 458.

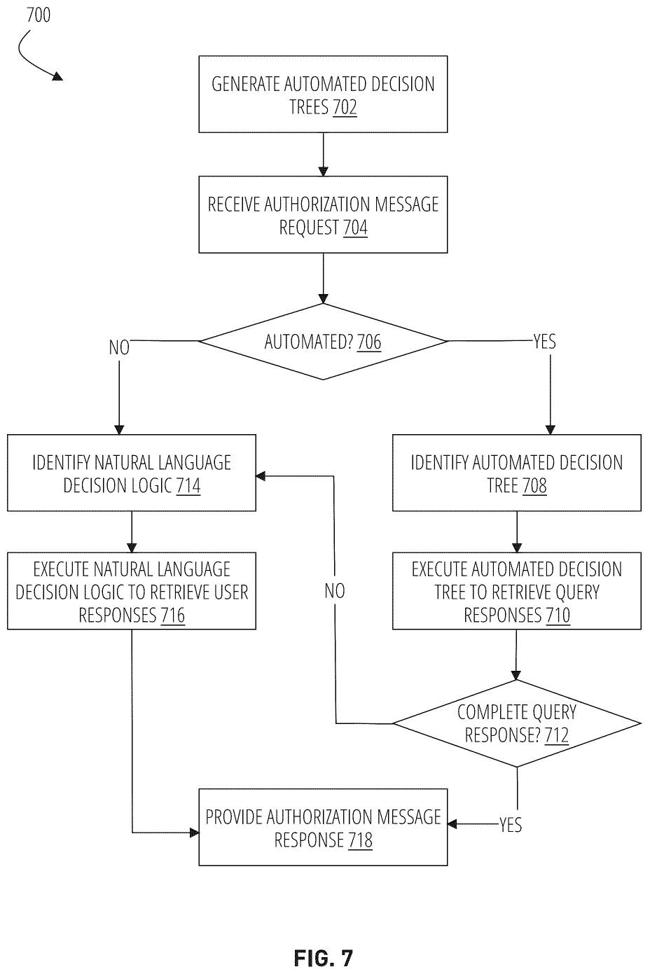

FIG. 7 is a flowchart diagram of an example sequential authorization process 700 in accordance with some embodiments discussed herein. The flowchart depicts a process 700 for implementing a sequential authorization messaging scheme that enables cross-entity collaboration between entities within an authorization computing ecosystem. The process 700 may be implemented by one or more computing devices, entities, and/or systems described herein. For example, via the various steps/operations of the process 700, the computing system 101 may leverage improved network messaging techniques to collaboratively and sequentially enforce authorization criteria across a plurality of computing entities within a computing environment. By doing so, the process 700 facilitates an automated authorization process that is directly tailored to addressing technical challenges of traditional network-based enforcement mechanisms and may be leveraged to improve both the processing time and efficiency of authorizing secured identifiers relative to the state of the art.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 includes, at step/operation 702, mapping predictive identifiers to predefined textual descriptions for the predictive identifiers. For example, the computing system 101 may identify a plurality of task relevant identifiers for a predictive task. The computing system 101 may identify a predefined textual description for the task relevant identifier.

In some embodiments, the process 700 includes, at step/operation 702, mapping predictive identifiers to predefined textual descriptions for the predictive identifiers. For example, the computing system 101 may identify a plurality of task relevant identifiers for a predictive task. The computing system 101 may identify a predefined textual description for the task relevant identifier.

In some embodiments, the process 700 includes, at step/operation 702, generating an automated decision tree. For example, the computing system 101 may generate an automated decision tree for a secured identifier. In some examples, the computing system 101 may generate a plurality of automated decision trees for a set of automated identifiers of the secured identifiers. The set of automated identifiers, for example, may be identifier based on a frequency of references to a secured identifier across a plurality of historical message data objects. In some examples, an automated decision tree may be stored as a supplement to a natural language decision logic in an authorization data object for a secured identifier. In some examples, one or more automated update messages may be provided to one or more computing entities (e.g., a query system, etc.) of the computing system 101 to continuously update the computing entities with respect to an automation status of the plurality of secured identifiers. In some examples, an automation indicator may be stored (e.g., in a lookup table, etc.) for each of the set of automated identifiers by one or more recipients of the one or more automated update messages.

In some embodiments, the process 700 includes, at step/operation 704, receiving an authorization message request. For example, the computing system 101 may receive an authorization message request. The authorization message request may include an automation indicator. The automation indicator, for example, may be previously provided to one or more computing entities (e.g., a query system, etc.) to identify the automated decision tree.

In some embodiments, the process 700 includes, at step/operation 706, determining whether an authorization message request corresponds to an automated identifier. For example, the computing system 101 may identify an automation indicator from the authorization message request. The computing system 101 may determine that the authorization message request corresponds to an automated identifier based on the automation indicator.

In the event that the authorization message request includes an automation indicator, in some embodiments, the process 700 includes, at step/operation 708, identifying an automated decision tree. For example, the computing system 101 may, in response to identifying the automation indicator, identify an automated decision tree associated with an automation indicator. In some examples, the automated decision tree includes a plurality of query branches. A query branch of the plurality of query branches may include a plurality of nodes and terminate at a terminal node that reflects a particular predictive response. A node of the plurality of nodes may include (a) query logic for performing a query and (b) routing logic for transitioning from the node to a subsequent node of the automated decision tree based on a query response to the query.

The computing system 101 may provide an automated query message request comprising the automated decision tree. For example, an authorization system of the computing system 101 may provide the automated query message request to the query system of the computing system 101. By way of example, the authorization message request may be received from a query system configured to perform one or more queries within a system-specific data source and the automated query message request may be provided to the query system to perform one or more queries based on the automated decision tree. For example, the automated decision tree may include a plurality of query branches and a query branch of the plurality of query branches may include a plurality of nodes respectively corresponding to a plurality of conditional queries to the system-specific data source.

In some embodiments, the process 700 includes, at step/operation 710, executing an automated decision tree to retrieve one or more query responses. For example, the computing system 101 may execute the query logic of one or more nodes of an automated decision tree to retrieve a sequence of query responses. The sequence of query responses may include one or more query responses respectively corresponding to one or more of the plurality of nodes. In some examples, the computing system 101 may receive an automated query message response including the sequence of query responses corresponding to one or more query branches of the automated decision tree. The automated query message response, for example, may be provided to the authorization system from the query system.

In some embodiments, the process 700 includes, at step/operation 712, determining a query completion status. For example, the computing system 101 may determine a query completion status of the automated query message response based on the sequence of query responses. The query completion status may identify a complete query response or an incomplete query response. The complete query response may indicate that the sequence of query responses terminates at the terminal node of an automated decision tree. The incomplete query response may indicate that the sequence of query responses terminates at one or more intermediate nodes preceding the terminal node.

In the event that the query completion status identifies a complete query response, at step/operation 712, the process 700 may proceed to step/operation 718. In addition, or alternatively, in the event that the query completion status identifies an incomplete query response, at step/operation 712, and/or the authorization message request does not include an automation indicator, at step/operation 706, the process 700 may proceed to step/operation 714, where the process 700 includes identifying a natural language decision logic.

For example, at step/operation 714, the computing system 101 may, in response to the query completion status identifying an incomplete query response, identify a natural language decision logic corresponding to the automated decision tree and provide a user query message request including the natural language decision logic to a query system.

In some embodiments, the process 700 includes, at step/operation 716, executing the natural language decision logic to retrieve one or more user responses. For example, the computing system 101 may execute the natural language decision logic to retrieve one or more user responses.

In some embodiments, the process 700 includes, at step/operation 718, providing an authorization message response. For example, the computing system 101 may provide an authorization message response including a predictive response based on the sequence of query responses and/or a sequence of user responses. In some examples, the authorization message response includes a textual response explanation for the predictive response. The computing system 101 may determine the predictive response based on a terminal node of an automated decision tree and/or a terminal condition of a natural language decision logic. In some examples, the computing system 101 may determine a textual response explanation for the predictive response based on the sequence of query responses and/or user responses. In some examples, the computing system 101 may store the predictive response, the textual response explanation, and/or the sequence of query responses in association with a response message identifier corresponding to the authorization message response.

Some techniques of the present disclosure enable the generation of action outputs that may be performed to initiate one or more real-world actions to achieve real-world effects. The sequential authorization techniques of the present disclosure may be used, applied, and/or otherwise leveraged to facilitate authorization operations for secured identifiers within an information domain. The authorization operations may trigger the performance of various computing tasks that improve the performance of a computing system (e.g., a computer itself, etc.) with respect to various actions performed by the computing system 101. Example actions may include the display, transmission, and/or the like of data reflective of an authorization process, such as alerts of an authorization for an entity, and/or the like. Moreover, the actions may include physical actions, such as a control of a robotic machine (e.g., medical equipment based on an authorization, etc.), and/or the like, that may be triggered in response to an authorization for a secured identifier.

A physical action, for example, may be caused by executing one or more control instructions in response to a predictive authorization. By way of example, in an automated delivery process for objects subject to authorization criteria, such as medication prescriptions, a physical action may be initiated in response to an authorization that includes controlling a robotic dispensing device to dispense the objects in accordance with the authorization. For instance, in an automated medical prescription use case, one or more control instructions may be provided to a robotic medication dispensing device (e.g., an automated tablet counter, a single- or multi-dose medication dispenser, etc.) to dispense an authorized prescription to a container for delivery to an entity. In some examples, the one or more control instructions may be provided to the robotic medication dispensing device by the authorization system and/or a remote distribution system located within a distribution facility.

In some examples, the computing tasks may include actions that may be based on an information domain. An information domain may include any environment in which computing systems may be applied to generate predictive insights and initiate the performance of computing tasks responsive to the predictive insights. These actions may cause real-world changes, for example, by controlling a hardware component, providing alerts, interactive actions, and/or the like. For instance, actions may include the initiation of automated instructions across and between devices, automated notifications, automated scheduling operations, automated precautionary actions, automated security actions, automated data processing actions, and/or the like.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising receiving, by one or more processors, an authorization message request comprising an automation indicator; identifying, by the one or more processors, the automation indicator from the authorization message request; in response to identifying the automation indicator, (i) identifying, by the one or more processors, an automated decision tree associated with the automation indicator, and (ii) providing, by the one or more processors, an automated query message request comprising the automated decision tree; receiving, by the one or more processors, an automated query message response comprising a sequence of query responses corresponding to one or more query branches of the automated decision tree; determining, by the one or more processors, a query completion status of the automated query message response based on the sequence of query responses; and in response to the query completion status identifying a complete query response, providing, by the one or more processors, an authorization message response comprising a predictive response based on the sequence of query responses.

Example 2. The computer-implemented method of example 1, wherein the authorization message request is received from a query system configured to perform one or more queries within a system-specific data source and the automated query message request is provided to the query system to perform the one or more queries based on the automated decision tree.

Example 3. The computer-implemented method of example 2, wherein the automation indicator is previously provided to the query system to identify the automated decision tree.

Example 4. The computer-implemented method of any of examples 2 through 3, wherein the automated decision tree comprises a plurality of query branches and a query branch of the plurality of query branches comprises a plurality of nodes respectively corresponding to a plurality of conditional queries to the system-specific data source.

Example 5. The computer-implemented method of example 4, wherein the sequence of query responses comprises one or more query responses respectively corresponding to one or more of the plurality of nodes.

Example 6. The computer-implemented method of any of the preceding examples, wherein (i) the automated decision tree comprises a plurality of query branches, (ii) a query branch of the plurality of query branches comprises a plurality of nodes and terminates at a terminal node that reflects a particular predictive response, and (iii) a node of the plurality of nodes comprises (a) query logic for performing a query and (b) routing logic for transitioning from the node to a subsequent node of the automated decision tree based on a query response to the query.

Example 7. The computer-implemented method of example 6, wherein (i) the query completion status identifies the complete query response or an incomplete query response, (ii) the complete query response indicates that the sequence of query responses terminates at the terminal node, and (iii) the incomplete query response indicates that the sequence of query responses terminates at one or more intermediate nodes preceding the terminal node.

Example 8. The computer-implemented method of any of the preceding examples, wherein the authorization message response comprises a textual response explanation for the predictive response and the computer-implemented method further comprises, in response to the query completion status identifying the complete query response determining the predictive response based on a terminal node of the automated decision tree; and determining a textual response explanation for the predictive response based on the sequence of query responses.

Example 9. The computer-implemented method of example 8, further comprising storing the predictive response, the textual response explanation, and the sequence of query responses in association with a response message identifier corresponding to the authorization message response.

Example 10. The computer-implemented method of any of the preceding examples, further comprising, in response to the query completion status identifying an incomplete query response identifying a natural language decision logic corresponding to the automated decision tree; and providing a user query message request including the natural language decision logic to a query system.

Example 11. A computing system comprising memory and one or more processors communicatively coupled to the memory, the one or more processors configured to receive an authorization message request comprising an automation indicator; identify, the automation indicator from the authorization message request; in response to identifying the automation indicator, (i) identify an automated decision tree associated with the automation indicator, and (ii) provide an automated query message request comprising the automated decision tree; receive an automated query message response comprising a sequence of query responses corresponding to one or more query branches of the automated decision tree; determine a query completion status of the automated query message response based on the sequence of query responses; and in response to the query completion status identifying a complete query response, provide an authorization message response comprising a predictive response based on the sequence of query responses.

Example 12. The computing system of example 11, wherein the authorization message request is received from a query system configured to perform one or more queries within a system-specific data source and the automated query message request is provided to the query system to perform the one or more queries based on the automated decision tree.

Example 13. The computing system of example 12, wherein the automation indicator is previously provided to the query system to identify the automated decision tree.

Example 14. The computing system of any of examples 12 through 13, wherein the automated decision tree comprises a plurality of query branches and a query branch of the plurality of query branches comprises a plurality of nodes respectively corresponding to a plurality of conditional queries to the system-specific data source.

Example 15. The computing system of example 14, wherein the sequence of query responses comprises one or more query responses respectively corresponding to one or more of the plurality of nodes.

Example 16. The computing system of example 11, wherein (i) the automated decision tree comprises a plurality of query branches, (ii) a query branch of the plurality of query branches comprises a plurality of nodes and terminates at a terminal node that reflects a particular predictive response, and (iii) a node of the plurality of nodes comprises (a) query logic for performing a query and (b) routing logic for transitioning from the node to a subsequent node of the automated decision tree based on a query response to the query.

Example 17. The computing system of example 16, wherein (i) the query completion status identifies the complete query response or an incomplete query response, (ii) the complete query response indicates that the sequence of query responses terminates at the terminal node, and (iii) the incomplete query response indicates that the sequence of query responses terminates at one or more intermediate nodes preceding the terminal node.

Example 18. One or more non-transitory computer-readable storage media including instructions that, when executed by one or more processors, cause the one or more processors to receive an authorization message request comprising an automation indicator; identify, the automation indicator from the authorization message request; in response to identifying the automation indicator, (i) identify an automated decision tree associated with the automation indicator, and (ii) provide an automated query message request comprising the automated decision tree; receive an automated query message response comprising a sequence of query responses corresponding to one or more query branches of the automated decision tree; determine a query completion status of the automated query message response based on the sequence of query responses; and in response to the query completion status identifying a complete query response, provide an authorization message response comprising a predictive response based on the sequence of query responses.

Example 19. The one or more non-transitory computer-readable storage media of example 18, wherein the authorization message response comprises a textual response explanation for the predictive response and the instructions further cause the one or more processors to, in response to the query completion status identifying the complete query response determine the predictive response based on a terminal node of the automated decision tree; and determine a textual response explanation for the predictive response based on the sequence of query responses.

Example 20. The one or more non-transitory computer-readable storage media of example 19, wherein the instructions further cause the one or more processors to store the predictive response, the textual response explanation, and the sequence of query responses in association with a response message identifier corresponding to the authorization message response.

1. A computer-implemented method comprising:
receiving, by one or more processors, an authorization message request comprising an automation indicator;
identifying, by the one or more processors, the automation indicator from the authorization message request;
in response to identifying the automation indicator,
(i) identifying, by the one or more processors, an automated decision tree associated with the automation indicator, and
(ii) providing, by the one or more processors, an automated query message request comprising the automated decision tree;
receiving, by the one or more processors, an automated query message response comprising a sequence of query responses corresponding to one or more query branches of the automated decision tree;
determining, by the one or more processors, a query completion status of the automated query message response based on the sequence of query responses; and
in response to the query completion status identifying a complete query response, providing, by the one or more processors, an authorization message response comprising a predictive response based on the sequence of query responses.

2. The computer-implemented method of claim 1, wherein the authorization message request is received from a query system configured to perform one or more queries within a system-specific data source and the automated query message request is provided to the query system to perform the one or more queries based on the automated decision tree.

3. The computer-implemented method of claim 2, wherein the automation indicator is previously provided to the query system to identify the automated decision tree.

4. The computer-implemented method of claim 2, wherein the automated decision tree comprises a plurality of query branches and a query branch of the plurality of query branches comprises a plurality of nodes respectively corresponding to a plurality of conditional queries to the system-specific data source.

5. The computer-implemented method of claim 4, wherein the sequence of query responses comprises one or more query responses respectively corresponding to one or more of the plurality of nodes.

6. The computer-implemented method of claim 1, wherein:
(i) the automated decision tree comprises a plurality of query branches,
(ii) a query branch of the plurality of query branches comprises a plurality of nodes and terminates at a terminal node that reflects a particular predictive response, and
(iii) a node of the plurality of nodes comprises (a) query logic for performing a query and (b) routing logic for transitioning from the node to a subsequent node of the automated decision tree based on a query response to the query.

7. The computer-implemented method of claim 6, wherein:
(i) the query completion status identifies the complete query response or an incomplete query response,
(ii) the complete query response indicates that the sequence of query responses terminates at the terminal node, and
(iii) the incomplete query response indicates that the sequence of query responses terminates at one or more intermediate nodes preceding the terminal node.

8. The computer-implemented method of claim 1, wherein the authorization message response comprises a textual response explanation for the predictive response and the computer-implemented method further comprises, in response to the query completion status identifying the complete query response:
determining the predictive response based on a terminal node of the automated decision tree; and
determining the textual response explanation for the predictive response based on the sequence of query responses.

9. The computer-implemented method of claim 8, further comprising storing the predictive response, the textual response explanation, and the sequence of query responses in association with a response message identifier corresponding to the authorization message response.

10. The computer-implemented method of claim 1, further comprising, in response to the query completion status identifying an incomplete query response:
identifying a natural language decision logic corresponding to the automated decision tree; and
providing a user query message request including the natural language decision logic to a query system.

11. A computing system comprising memory and one or more processors communicatively coupled to the memory, the one or more processors configured to:
receive an authorization message request comprising an automation indicator;
identify, the automation indicator from the authorization message request;
in response to identifying the automation indicator,
(i) identify an automated decision tree associated with the automation indicator, and
(ii) provide an automated query message request comprising the automated decision tree;
receive an automated query message response comprising a sequence of query responses corresponding to one or more query branches of the automated decision tree;
determine a query completion status of the automated query message response based on the sequence of query responses; and
in response to the query completion status identifying a complete query response, provide an authorization message response comprising a predictive response based on the sequence of query responses.

12. The computing system of claim 11, wherein the authorization message request is received from a query system configured to perform one or more queries within a system-specific data source and the automated query message request is provided to the query system to perform the one or more queries based on the automated decision tree.

13. The computing system of claim 12, wherein the automation indicator is previously provided to the query system to identify the automated decision tree.

14. The computing system of claim 12, wherein the automated decision tree comprises a plurality of query branches and a query branch of the plurality of query branches comprises a plurality of nodes respectively corresponding to a plurality of conditional queries to the system-specific data source.

15. The computing system of claim 14, wherein the sequence of query responses comprises one or more query responses respectively corresponding to one or more of the plurality of nodes.

16. The computing system of claim 11, wherein:
(i) the automated decision tree comprises a plurality of query branches,
(ii) a query branch of the plurality of query branches comprises a plurality of nodes and terminates at a terminal node that reflects a particular predictive response, and
(iii) a node of the plurality of nodes comprises (a) query logic for performing a query and (b) routing logic for transitioning from the node to a subsequent node of the automated decision tree based on a query response to the query.

17. The computing system of claim 16, wherein:
(i) the query completion status identifies the complete query response or an incomplete query response,
(ii) the complete query response indicates that the sequence of query responses terminates at the terminal node, and
(iii) the incomplete query response indicates that the sequence of query responses terminates at one or more intermediate nodes preceding the terminal node.

18. One or more non-transitory computer-readable storage media including instructions that, when executed by one or more processors, cause the one or more processors to:
receive an authorization message request comprising an automation indicator;
identify, the automation indicator from the authorization message request;
in response to identifying the automation indicator,
(i) identify an automated decision tree associated with the automation indicator, and
(ii) provide an automated query message request comprising the automated decision tree;
receive an automated query message response comprising a sequence of query responses corresponding to one or more query branches of the automated decision tree;
determine a query completion status of the automated query message response based on the sequence of query responses; and
in response to the query completion status identifying a complete query response, provide an authorization message response comprising a predictive response based on the sequence of query responses.

19. The one or more non-transitory computer-readable storage media of claim 18, wherein the authorization message response comprises a textual response explanation for the predictive response and the instructions further cause the one or more processors to, in response to the query completion status identifying the complete query response:
determine the predictive response based on a terminal node of the automated decision tree; and
determine the textual response explanation for the predictive response based on the sequence of query responses.

20. The one or more non-transitory computer-readable storage media of claim 19, wherein the instructions further cause the one or more processors to store the predictive response, the textual response explanation, and the sequence of query responses in association with a response message identifier corresponding to the authorization message response.
